(19) United States
(12) Patent Application Publication
(10) Pub. No.: US 2024/0193688 A1
(43) Pub. Date: Jun. 13, 2024

(54) METHODS AND SYSTEMS FOR TRANSFERRING DATA TOKENS BETWEEN AUTONOMOUS AGENTS

(71) Applicant: Krypton Labs, Inc., Los Angeles, CA (US)

(72) Inventors: Michael Christoph Nowotny, Los Angeles, CA (US); Jenish C. Mehta, Gujarat (IN)

(21) Appl. No.: 18/534,348

(22) Filed: Dec. 8, 2023

Related U.S. Application Data
(60) Provisional application No. 63/431,392, filed on Dec. 9, 2022.

(51) Int. Cl. G06Q 40/04

(52) U.S. Cl. CPC G06Q 40/04; G06Q 2220/00

(57) ABSTRACT

The present disclosure generally relates to methods, systems, apparatuses, and non-transitory computer readable media for transferring data tokens between autonomous agents. These methods and systems allow data token transfers to happen in a fair manner. At a high level, each of these autonomous agents may be associated with one or more requests to transfer data tokens. In addition to specifying a desired quantity of data tokens to be traded, these requests may also specify—either directly or indirectly—a rate at which the data tokens will be traded. This contrasts to traditional systems, which often involve only instantaneous transfers—which are essentially transfers with an infinitely high trading rate.

### CROSS-REFERENCE TO RELATED APPLICATION

This application claims the benefit of U.S. Provisional Patent Application No. 63/431,392, filed Dec. 9, 2022, which is incorporated by reference herein in its entirety.

### BACKGROUND

### Technical Field

The present disclosure generally relates to data token transfers, and more particularly, methods, systems, apparatuses, and non-transitory computer readable media for transferring data tokens between autonomous agents.

### Description of the Background

Order matching systems are a component in the architecture of electronic trading platforms, serving as the mechanism by which buy and sell orders are paired and executed within various financial markets. At their core, these systems function by aligning the interests of buyers and sellers, with the primary objective of facilitating the exchange of securities, commodities, or other tradable instruments at an agreed-upon price. The reliability of order matching systems are paramount, as they directly impact the fluidity and stability of financial transactions on a global scale.

These systems are typically embedded within a broader electronic trading infrastructure, which encompasses a range of functionalities including order entry, order routing, transaction processing, and market data dissemination. The integration of order matching systems within this larger framework is essential, as it enables the seamless flow of orders through the various stages of a trade lifecycle, from initiation to settlement. The sophistication of these systems allows them to handle not only the matching process but also to ensure compliance with market rules and regulations, maintain the integrity of the trading environment, and provide market participants with a fair and orderly market.

In the context of electronic trading, order matching systems have largely replaced manual methods of trade execution, offering significant advantages in terms of speed, accuracy, and capacity. However, building upon the foundational role of order matching systems within electronic trading platforms, their importance extends to the broader objectives of the timely clearing of trades, the ability to absorb liquidity and movements thereof, the timely updating of order books or inventory states, and the orderly execution of transactions.

The role of order matching systems transcends the mere pairing of buy and sell orders; they are a cornerstone of modern financial markets. The significance of order matching systems is underscored by their widespread application across a diverse array of market types, each with its own set of requirements and characteristics. These systems are not one-size-fits-all solutions; rather, they are tailored to address the specific nuances of the markets they serve.

Furthermore, each market type requires an order matching system that is configured with its particular trading instruments, market participants, and regulatory environment in mind. Moreover, the adaptability and customization of these systems are crucial in managing the distinct trading conditions present in each type of market, ensuring that they continue to meet the evolving needs of market participants and maintain the integrity of the trading process. For example, adapting to the specificities of each market, order matching systems are engineered to handle a multitude of functional considerations that dictate how orders are prioritized and executed.

The diversity in order types is a testament to the sophistication required of these systems to accommodate the strategic needs of market participants. Market orders, which are executed at the best available price, and limit orders, which set a maximum or minimum price at which a trader is willing to buy or sell, are two example order types amongst a variety of other order types. For example, traders also utilize stop orders, which become active only after a certain price threshold is reached, and more intricate order types like iceberg orders, which conceal the actual order quantity to prevent large orders from disrupting the market.

Returning generally to matching systems, the prioritization of orders within a matching system is typically based on a set of well-defined criteria. Price priority is the most fundamental, ensuring that the best available bid or ask prices are matched first. Time priority can also be a factor, as it rewards the placement of orders earlier in time with a higher chance of execution. Additionally, the size of the order can be a factor, with some systems offering priority to larger orders, while others may fill smaller orders first to facilitate participation by retail investors.

Moreover, the type of market participant can influence the matching process and system. For example, certain systems may provide different priority or fees for retail investors versus institutional traders, or for market makers who provide liquidity versus those who take liquidity.

The functionality of these systems extends beyond the mere matching of orders. They are also responsible for managing order queues, handling cancellations and modifications, and ensuring that trades are executed in compliance with market rules. For example, these may include the enforcement of trading halts during periods of extreme volatility or the implementation of circuit breakers to prevent disorderly market conditions.

In essence, order matching systems are subject to a range of technical and operational challenges that must be managed to ensure their smooth operation within the financial markets. One of the most significant challenges is the need to handle high volumes of orders, which can surge dramatically during periods of market volatility or economic announcements. Systems must be configured to have the capacity to process these peaks in activity, ensuring maintenance of orderly trading conditions.

High-frequency trading (HFT) presents another layer of complexity, as it involves the execution of orders at extremely high speeds, often by automated trading algorithms. Order matching systems must be equipped to interact with these algorithms effectively, managing the rapid submission, modification, and cancellation of orders that characterize HFT activity. The systems must be robust enough to withstand potential stresses and strains caused by such trading behavior while preventing any form of market manipulation or unfair advantage.

Regulatory compliance is a further challenge. Financial markets are subject to a stringent regulatory framework designed to protect investors and ensure fair and transparent trading. Order matching systems must therefore incorporate mechanisms to enforce regulatory requirements, such as trade reporting, market surveillance, and compliance with best execution policies. These systems must also be able to adapt to changes in regulation, which can arise as lawmakers respond to new market developments or financial crises.

Security concerns are another challenge, given the potential for cyber threats and data breaches in today's interconnected digital landscape. Order matching systems must employ advanced security measures to safeguard sensitive financial data and protect against unauthorized access or cyber-attacks. Ensuring the integrity and confidentiality of trading activity is essential for maintaining investor trust and the proper functioning of financial markets.

As such, the technical and operational challenges faced by order matching systems are multifaceted and continually evolving. The systems must be engineered to manage high order volumes, to interact with high-frequency trading activities, to adapt to the specific microstructure of each market, to comply with regulatory standards, and to uphold stringent security protocols. These challenges necessitate a continuous process for monitoring, updating, and refining order matching systems to ensure that they remain effective and resilient in the face of an ever-changing trading environment.

Market demands also drive innovation in order matching systems. As traders and investors seek more sophisticated trading options and strategies, systems must evolve to offer new functionalities and order types. This includes the ability to execute complex multi-legged strategies, provide advanced risk management tools, and offer more granular control over order execution.

Accordingly, methods and systems for transferring data, in particular, methods and systems for transferring data tokens between autonomous agents are greatly desired.

### SUMMARY

In some aspects, the techniques described herein relate to a method for transferring data tokens between autonomous agents, including: generating a transmit curve based on parameters of a plurality of queued transfer requests, wherein each transfer request of the plurality of queued transfer requests is associated with one of a plurality of autonomous agents; generating a receive curve based on the parameters of the plurality of queued transfer requests; and queuing one or more transfers of data tokens between the autonomous agents for a period of time between a start timestamp until an end timestamp by: (1) calculating an intersection weight based on the transmit curve and the receive curve; (2) for an initial iteration, selecting a current subset of active queued transfer requests from the plurality of queued transfer requests based on the intersection weight and the parameters of the plurality of queued transfer requests; (3) calculating a current minimum time interval based on the parameters of the current subset of active queued transfer requests; (4) recording the one or more queued transfers of data tokens between a subset of active autonomous agents based on the current minimum time interval and the parameters of the current subset of active queued transfer requests, wherein the subset of active autonomous agents is a subset of the plurality of autonomous agents that are associated with at least one queued transfer request of the current subset of active queued transfer requests; (5) updating the parameters of the current subset of active queued transfer requests based on the one or more queued transfers; (6) replacing the current subset of active queued transfer requests with a new subset of active queued transfer requests calculated by removing any queued transfer requests from the current subset of active queued transfer requests that are no longer active; (7) advancing the start timestamp by the current minimum time interval; and (8) iteratively repeating steps (1) through (8) until the start timestamp matches the end timestamp.

In some aspects, the techniques described herein relate to a method, further including transferring the data tokens between the plurality of autonomous agents based on the one or more recorded queued transfers.

In some aspects, the techniques described herein relate to a method, wherein the start timestamp and the end timestamp are each a rational number stored as a fixed-point number having a fixed precision for a fractional part of the fixed-point number.

In some aspects, the techniques described herein relate to a method, wherein the current minimum time interval is a fractional number stored as a 2-tuple of a first integral number and a second integral number, wherein: the first integral number represents a numerator of the fractional number; and the second integral number represents a denominator of the fractional number.

In some aspects, the techniques described herein relate to a method, further including determining the end timestamp by: iterating through the parameters of a plurality of pending transfer requests to determine if any of the plurality of pending transfer requests have an initial operation timestamp between the start timestamp and a requested final timestamp, wherein each of the plurality of pending transfer requests is received from and is associated with one of the plurality of autonomous agents; and in response to determining there is at least one of the plurality of pending transfer requests that has the initial operation timestamp between the start timestamp and the requested final timestamp: determining an earliest initial operation timestamp of the plurality of pending transfer requests; comparing the earliest initial operation timestamp of the plurality of pending transfer requests with the requested final timestamp; and based on the comparison, selecting as the end timestamp the earlier of the earliest initial operation timestamp and the requested final timestamp.

In some aspects, the techniques described herein relate to a method, wherein: each of the plurality of queued transfer requests is associated with resource parameters, wherein the resource parameters include a first resource parameter indicating quantity and a second resource parameter indicating a transfer sign; and each of the plurality of queued transfer requests is further associated with control parameters, wherein the control parameters include a first control parameter indicating an upper resource weight and a second control parameter indicating a lower resource weight.

In some aspects, the techniques described herein relate to a method, wherein: the control parameters associated with each of the plurality of queued transfer requests further include a parameter indicating a maximum flow rate; and for each of the plurality of queued transfer requests, the maximum flow rate is linearly distributed between the lower resource weight indicated by the control parameters of a queued transfer request and the upper resource weight indicated by the control parameters of the queued transfer request.

In some aspects, the techniques described herein relate to a method, wherein: the control parameters associated with each of the plurality of queued transfer requests further include a first parameter indicating a maximum flow rate and a second parameter indicating a flow rate distribution function; and for each of the plurality of queued transfer requests, the maximum flow rate is distributed between the lower resource weight indicated by the control parameters of a queued transfer request and the upper resource weight indicated by the control parameters of the queued transfer request based on the flow rate distribution function indicated by the control parameters of the queued transfer request.

In some aspects, the techniques described herein relate to a method, wherein, for each of the plurality of queued transfer requests, the flow rate distribution function indicated by the control parameters of the queued transfer request is log-linear with respect to resource weight.

In some aspects, the techniques described herein relate to a method, wherein: each of the plurality of queued transfer requests is associated with resource parameters, wherein the resource parameters include a first parameter indicating quantity and a second parameter indicating a transfer sign; each of the plurality of queued transfer requests is further associated with control parameters, wherein the control parameters include at least three parameters indicating: (1) an upper resource weight, (2) a lower resource weight, (3) a maximum flow rate, and (4) a flow rate slope; and the transmit curve and the receive curve are generated based on the control parameters associated with each of the plurality of queued transfer requests.

In some aspects, the techniques described herein relate to a method, wherein selecting the current subset of active queued transfer requests for the initial iteration includes: iterating through the plurality of queued transfer requests; selecting each queued transfer request associated with a parameter indicating an upper resource weight that is greater than the intersection weight and a parameter indicating lower resource weight that is less than the intersection weight; and adding each selected queued transfer request to the current subset of active queued transfer requests.

In some aspects, the techniques described herein relate to a method, wherein calculating the current minimum time interval includes: for each queued transfer request in the current subset of active queued transfer requests, calculating an amount of time that the first parameter indicating quantity of a queued transfer request will be satisfied, wherein the amount of time is calculated based on a current flow rate derived from the control parameters of the queued transfer request and the intersection weight; and selecting the least of the calculated amounts of time as the current minimum time interval.

In some aspects, the techniques described herein relate to a method, wherein: the transmit curve is a first piecewise linear curve included of a transmit curve start point, a transmit curve end point, and a plurality of transmit curve intermediate points, and the receive curve is a second piecewise linear curve included of a receive curve start point, a receive curve end point, and a plurality of receive curve intermediate points, wherein: each transmit curve point and each receive curve point is associated with curve point parameters; and the curve point parameters include at least two parameters indicating: (1) a resource weight, (2) a flow rate, and (3) a flow rate slope.

In some aspects, the techniques described herein relate to a method, wherein: the control parameters for each of the plurality of queued transfer requests are each a rational number stored as a fixed-point number having a fixed precision for a fractional part of the fixed-point number; and the curve point parameters for each transmit curve point, and for each receive curve point, are each a rational number stored as a fixed-point number having a fixed precision for a fractional part of the fixed-point number.

In some aspects, the techniques described herein relate to a method, wherein calculating the intersection weight includes: iterating through transmit curve points to determine a first transmit corner point and a second transmit corner point, wherein: the first transmit corner point and the second transmit corner point are adjacent; the first transmit corner point is associated with the curve point parameters indicating a first resource weight and a first flow rate such that: the first flow rate is less than a second flow rate of the receive curve at the first resource weight; and there is no other point of the transmit curve that is associated with the curve point parameters indicating a second resource weight and a third flow rate such that: (1) the third flow rate that is greater than the first flow rate; (2) the second resource weight is greater than the first resource weight; and (3) the third flow rate is less than a fourth flow rate of the receive curve at the second resource weight; and the second transmit corner point is associated with the curve point parameters indicating a third resource weight and a fifth flow rate such that: the fifth flow rate is greater than a sixth flow rate of the receive curve at the third resource weight; and there is no other point of the transmit curve that is associated with the curve point parameters indicating a fourth resource weight and a seventh flow rate such that: (1) the seventh flow rate that is less than the fifth flow rate; (2) the fourth resource weight is less than the third resource weight; and (3) the seventh flow rate is greater than an eighth flow rate of the receive curve at the fourth resource weight; iterating through receive curve points to determine a first receive corner point and a second receive corner point, wherein: the first receive corner point and the second receive corner point are adjacent; the first receive corner point is associated with the curve point parameters indicating a fifth resource weight and a ninth flow rate such that: the ninth flow rate is less than a tenth flow rate of the transmit curve at the fifth resource weight; and there is no other point of the receive curve that is associated with the curve point parameters indicating a sixth resource weight and an eleventh flow rate such that: (1) the eleventh flow rate that is greater than the ninth flow rate; (2) the sixth resource weight is less than the fourth resource weight; and (3) the eleventh flow rate is less than a twelfth flow rate of the transmit curve at the sixth resource weight; and the second receive corner point is associated with the curve point parameters indicating a seventh resource weight and a thirteenth flow rate such that: the thirteenth flow rate is greater than a fourteenth flow rate of the transmit curve at the seventh resource weight; and there is no other point of the receive curve that is associated with the curve point parameters indicating an eighth resource weight and a fifteenth flow rate such that: (1) the fifteenth flow rate that is less than the thirteenth flow rate; (2) the eighth resource weight is greater than the seventh resource weight; and (3) the fifteenth flow rate is greater than a sixteenth flow rate of the transmit curve at the eighth resource weight; calculating an intersection point between a first line between the first transmit corner point and second transmit corner point and a second line between the first receive corner point and second receive corner point, wherein the calculated intersection point is associated with a resource weight, a flow rate slope, and a flow rate; and using the resource weight of the calculated intersection point as the intersection weight.

In some aspects, the techniques described herein relate to a method, further including: calculating the transmit curve by: determining, for each of the plurality of queued transfer requests associated with a negative transfer sign, an upper resource weight, and a lower resource rate, wherein the upper resource weight and the lower resource weight are determined based on the control parameters associated with each of the plurality of queued transfer requests; generating a point for each upper resource weights and lower resource weights associated with the plurality of queued transfer requests associated with a negative transfer sign, wherein each generated point is associated with a respective one of the determined upper resource weights and the determined lower resource weights; determining, for each generated point, the curve point parameters, wherein: determining, for a generated point, a parameter indicating resource weight includes setting the parameter indicating resource weight to the determined resource weights associated with the generated point; determining, for a generated point, a parameter indicating a flow rate slope includes: determining, for each of the plurality of queued transfer requests associated with a negative transfer sign, a flow rate slope, wherein the flow rate slope is determined based on the control parameters associated with each of the plurality of queued transfer requests; and composing respective flow rate slopes associated with the plurality of queued transfer requests associated with a negative transfer sign; and determining, for a generated point, a flow rate parameter includes: determining, for each of the plurality of queued transfer requests associated with a negative transfer sign, a maximum flow rate, wherein the maximum flow rate is determined based on the control parameters associated with each of the plurality of queued transfer requests; and composing respective maximum flow rates associated with the plurality of queued transfer requests associated with a negative transfer sign; and calculating the receive curve by: determining, for each of the plurality of queued transfer requests associated with a positive transfer sign, an upper resource weight and a lower resource rate, wherein the upper resource weight and the lower resource weight are determined based on the control parameters associated with each of the plurality of queued transfer requests; generating a point for each of the determined resource weights associated with the plurality of queued transfer requests associated with a positive transfer sign, wherein each generated point is associated with a respective one of the determined upper resource weights and the determined lower resource weights; and determining, for each generated point, the curve point parameters, wherein: determining, for a generated point, a parameter indicating resource weight includes setting the parameter indicating resource weight to the determined resource weight associated with the generated point; determining, for a generated point, a parameter indicating a flow rate slope includes: determining, for each of the plurality of queued transfer requests associated with a positive transfer sign, a flow rate slope, wherein the flow rate slope is determined based on the control parameters associated with each of the plurality of queued transfer requests; and composing the respective flow rate slopes associated with the plurality of queued transfer requests associated with a positive transfer sign; and determining, for a generated point, a flow rate parameter includes: determining, for each of the plurality of queued transfer requests associated with a positive transfer sign, a maximum flow rate, wherein the maximum flow rate is determined based on the control parameters associated with each of the plurality of queued transfer requests; and composing the respective maximum flow rates associated with the plurality of queued transfer requests associated with a positive transfer sign.

In some aspects, the techniques described herein relate to a system for transferring data tokens between autonomous agents, including: one or more memories storing a set of instructions; and one or more processors in communication with the one or more memories that are configured to execute the set of instructions stored in the one or more memories, wherein the one or more processors executing the set of instructions causes the system to: generate a transmit curve based on parameters of a plurality of queued transfer requests, wherein each transfer request of the plurality of queued transfer requests is associated with one of a plurality of autonomous agents; generate a receive curve based on the parameters of the plurality of queued transfer requests; and queue the one or more transfers of data tokens between the autonomous agents for a period of time between a start timestamp until an end timestamp by: (1) calculating an intersection weight based on the transmit curve and the receive curve; (2) for an initial iteration, selecting a current subset of active queued transfer requests from the plurality of queued transfer requests based on the intersection weight and the parameters of the plurality of queued transfer requests; (3) calculating a current minimum time interval based on the parameters of the current subset of active queued transfer requests; (4) recording one or more queued transfers of data tokens between a subset of active autonomous agents based on the current minimum time interval and the parameters of the current subset of active queued transfer requests, wherein the subset of active autonomous agents is a subset of the plurality of autonomous agents that are associated with at least one queued transfer request of the current subset of active queued transfer requests; (5) updating the parameters of the current subset of active queued transfer requests based on the one or more queued transfers; (6) replacing the current subset of active queued transfer requests with a new subset of active queued transfer requests calculated by removing any queued transfer requests from the current subset of active queued transfer requests that are no longer active; (7) advancing the start timestamp by the current minimum time interval; and (8) iteratively repeating steps (1) through (8) until the start timestamp matches the end timestamp.

In some aspects, the techniques described herein relate to a system, wherein the one or more processors executing the set of instructions further cause the system to transfer the data tokens between the plurality of autonomous agents based on the one or more recorded queued transfers.

In some aspects, the techniques described herein relate to a system, wherein the start timestamp and the end timestamp are each a rational value stored as a fixed-point number having a fixed precision for a fractional part of the fixed-point number.

In some aspects, the techniques described herein relate to a system, wherein the current minimum time interval is a fractional number stored as a 2-tuple of a first integral number and a second integral number, wherein: the first integral number represents a numerator of the fractional number; and the second integral number represents a denominator of the fractional number.

In some aspects, the techniques described herein relate to a system, wherein the one or more processors executing the set of instructions further cause the system to determine the end timestamp by: iterating through the parameters of a plurality of pending transfer requests to determine if any of the plurality of pending transfer requests have an initial operation timestamp between the start timestamp and a requested final timestamp, wherein each of the plurality of pending transfer requests is received from and is associated with one of the plurality of autonomous agents; and in response to determining there is at least one of the plurality of pending transfer requests that has the initial operation timestamp between the start timestamp and the requested final timestamp: determining an earliest initial operation timestamp of the plurality of pending transfer requests; comparing the earliest initial operation timestamp of the plurality of pending transfer requests with the requested final timestamp; and based on the comparison, selecting as the end timestamp the earlier of the earliest initial operation timestamp and the requested final timestamp.

In some aspects, the techniques described herein relate to a system, wherein: each of the plurality of queued transfer requests is associated with resource parameters, wherein the resource parameters include a first resource parameter indicating quantity and a second resource parameter indicating a transfer sign; and each of the plurality of queued transfer requests is further associated with control parameters, wherein the control parameters include a first control parameter indicating an upper resource weight and a second control parameter indicating a lower resource weight.

In some aspects, the techniques described herein relate to a system, wherein: the control parameters associated with each of the plurality of queued transfer requests further include a parameter indicating a maximum flow rate; and for each of the plurality of queued transfer requests, the maximum flow rate is linearly distributed between the lower resource weight indicated by the control parameters of a queued transfer request and the upper resource weight indicated by the control parameters of the queued transfer request.

In some aspects, the techniques described herein relate to a system, wherein: the control parameters associated with each of the plurality of queued transfer requests further include a first parameter indicating a maximum flow rate and a second parameter indicating a flow rate distribution function; and for each of the plurality of queued transfer requests, the maximum flow rate is distributed between the lower resource weight indicated by the control parameters of a queued transfer request and the upper resource weight indicated by the control parameters of the queued transfer request based on the flow rate distribution function indicated by the control parameters of the queued transfer request.

In some aspects, the techniques described herein relate to a system, wherein, for each of the plurality of queued transfer requests, the flow rate distribution function indicated by the control parameters of the queued transfer request is log-linear with respect to resource weight.

In some aspects, the techniques described herein relate to a system, wherein: each of the plurality of queued transfer requests is associated with resource parameters, wherein the resource parameters include a first parameter indicating quantity and a second parameter indicating a transfer sign; each of the plurality of queued transfer requests is further associated with control parameters, wherein the control parameters include at least three parameters indicating: (1) an upper resource weight, (2) a lower resource weight, (3) a maximum flow rate, and (4) a flow rate slope; and the transmit curve and the receive curve are generated based on the control parameters associated with each of the plurality of queued transfer requests.

In some aspects, the techniques described herein relate to a system, wherein the one or more processors executing the set of instructions cause the system to select the current subset of active queued transfer requests for the initial iteration by: iterating through the plurality of queued transfer requests; selecting each queued transfer request associated with a parameter indicating an upper resource weight that is greater than the intersection weight and a parameter indicating lower resource weight that is less than the intersection weight; and adding each selected queued transfer request to the current subset of active queued transfer requests.

In some aspects, the techniques described herein relate to a system, wherein the one or more processors executing the set of instructions cause the system to calculate the current minimum time interval by: for each queued transfer request in the current subset of active queued transfer requests, calculating an amount of time that the first parameter indicating quantity of a queued transfer request will be satisfied, wherein the amount of time is calculated based on a current flow rate derived from the control parameters of the queued transfer request and the intersection weight; and selecting the least of the calculated amounts of time as the current minimum time interval.

In some aspects, the techniques described herein relate to a system, wherein: the transmit curve is a first piecewise linear curve included of a transmit curve start point, a transmit curve end point, and a plurality of transmit curve intermediate points, and the receive curve is a second piecewise linear curve included of a receive curve start point, a receive curve end point, and a plurality of receive curve intermediate points, wherein: each transmit curve point and each receive curve point is associated with curve point parameters; and the curve point parameters include at least two parameters indicating: (1) a resource weight, (2) a flow rate, and (3) a flow rate slope.

In some aspects, the techniques described herein relate to a system, wherein: the control parameters for each of the plurality of queued transfer requests are each a rational number stored as a fixed-point number having a fixed precision for a fractional part of the fixed-point number; and the curve point parameters for each the transmit curve point, and for each receive curve point, are each a rational value stored as a fixed-point number having a fixed precision for a fractional part of the fixed-point number.

In some aspects, the techniques described herein relate to a system, wherein the one or more processors executing the set of instructions cause the system to calculate the intersection weight by: iterate through transmit curve points to determine a first transmit corner point and a second transmit corner point, wherein: the first transmit corner point and the second transmit corner point are adjacent; the first transmit corner point is associated with the curve point parameters indicating a first resource weight and a first flow rate such that: the first flow rate is less than a second flow rate of the receive curve at the first resource weight; and there is no other point of the transmit curve that is associated with the curve point parameters indicating a second resource weight and a third flow rate such that: (1) the third flow rate that is greater than the first flow rate; (2) the second resource weight is greater than the first resource weight; and (3) the third flow rate is less than a fourth flow rate of the receive curve at the second resource weight; and the second transmit corner point is associated with the curve point parameters indicating a third resource weight and a fifth flow rate such that: the fifth flow rate is greater than a sixth flow rate of the receive curve at the third resource weight; and there is no other point of the transmit curve that is associated with the curve point parameters indicating a fourth resource weight and a seventh flow rate such that: (1) the seventh flow rate that is less than the fifth flow rate; (2) the fourth resource weight is less than the third resource weight; and (3) the seventh flow rate is greater than an eighth flow rate of the receive curve at the fourth resource weight; iterate through the receive curve points to determine a first receive corner point and a second receive corner point, wherein: the first receive corner point and the second receive corner point are adjacent; the first receive corner point is associated with the curve point parameters indicating a fifth resource weight and a ninth flow rate such that: the ninth flow rate is less than a tenth flow rate of the transmit curve at the fifth resource weight; and there is no other point of the receive curve that is associated with the curve point parameters indicating a sixth resource weight and an eleventh flow rate such that: (1) the eleventh flow rate that is greater than the ninth flow rate; (2) the sixth resource weight is less than the fourth resource weight; and (3) the eleventh flow rate is less than a twelfth flow rate of the transmit curve at the sixth resource weight; and the second receive corner point is associated with the curve point parameters indicating a seventh resource weight and a thirteenth flow rate such that: the thirteenth flow rate is greater than a fourteenth flow rate of the transmit curve at the seventh resource weight; and there is no other point of the receive curve that is associated with the curve point parameters indicating an eighth resource weight and a fifteenth flow rate such that: (1) the fifteenth flow rate that is less than the thirteenth flow rate; (2) the eighth resource weight is greater than the seventh resource weight; and (3) the fifteenth flow rate is greater than a sixteenth flow rate of the transmit curve at the eighth resource weight; calculate an intersection point between a first line between the first transmit corner point and second transmit corner point and a second line between the first receive corner point and second receive corner point, wherein the calculated intersection point is associated with a resource weight, a flow rate slope, and a flow rate; and use the resource weight of the calculated intersection point as the intersection weight.

In some aspects, the techniques described herein relate to a system, wherein the one or more processors executing the set of instructions further cause the system to: calculate the transmit curve by: determining, for each of the plurality of queued transfer requests associated with a negative transfer sign, an upper resource weight, and a lower resource rate, wherein the upper resource weight and the lower resource weight are determined based on the control parameters associated with each of the plurality of queued transfer requests; generating a point for each upper resource weights and lower resource weights associated with the plurality of queued transfer requests associated with a negative transfer sign, wherein each generated point is associated with a respective one of the determined upper resource weights and the determined lower resource weights; determining, for each generated point, curve point parameters, wherein: determining, for a generated point, a parameter indicating resource weight includes setting the parameter indicating resource weight to the determined resource weights associated with the generated point; determining, for a generated point, a parameter indicating a flow rate slope includes: determining, for each of the plurality of queued transfer requests associated with a negative transfer sign, a flow rate slope, wherein the flow rate slope is determined based on the control parameters associated with each of the plurality of queued transfer requests; and composing respective flow rate slopes associated with the plurality of queued transfer requests associated with a negative transfer sign; and determining, for a generated point, a flow rate parameter includes: determining, for each of the plurality of queued transfer requests associated with a negative transfer sign, a maximum flow rate, wherein the maximum flow rate is determined based on the control parameters associated with each of the plurality of queued transfer requests; and composing respective maximum flow rates associated with the plurality of queued transfer requests associated with a negative transfer sign; and calculate the receive curve by: determining, for each of the plurality of queued transfer requests associated with a positive transfer sign, an upper resource weight and a lower resource rate, wherein the upper resource weight and the lower resource weight are determined based on the control parameters associated with each of the plurality of queued transfer requests; generating a point for each of the determined resource weights associated with the plurality of queued transfer requests associated with a positive transfer sign, wherein each generated point is associated with a respective one of the determined upper resource weights and the determined lower resource weights; and determining, for each generated point, the curve point parameters, wherein: determining, for a generated point, a parameter indicating resource weight includes setting the parameter indicating resource weight to the determined resource weight associated with the generated point; determining, for a generated point, a parameter indicating a flow rate slope includes: determining, for each of the plurality of queued transfer requests associated with a positive transfer sign, a flow rate slope, wherein the flow rate slope is determined based on the control parameters associated with each of the plurality of queued transfer requests; and composing the respective flow rate slopes associated with the plurality of queued transfer requests associated with a positive transfer sign; and determining, for a generated point, a flow rate parameter includes: determining, for each of the plurality of queued transfer requests associated with a positive transfer sign, a maximum flow rate, wherein the maximum flow rate is determined based on the control parameters associated with each of the plurality of queued transfer requests; and composing the respective maximum flow rates associated with the plurality of queued transfer requests associated with a positive transfer sign.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a flowchart of a method of queuing data token exchanges for minimum time steps until an end timestamp is reached, according to the present disclosure.

FIG. 2 is a block diagram of a token exchange system according to some embodiments of the present disclosure.

FIG. 3 is a flowchart of a method of transferring data tokens between autonomous agents according to some embodiments of the present disclosure.

FIG. 4 is a simplified schematic illustrating a computing device, according to the present disclosure.

FIG. 5 is a flowchart of a method of calculating an intersection price and a minimum time step, according to the present disclosure.

FIG. 6 is a flowchart of a method of queueing data token exchanges for a minimum time step, according to the present disclosure.

FIG. 7 is a flowchart of a method of timing the execution of a receive transaction, according to the present disclosure.

FIG. 8 is a flowchart of a method of timing the execution of a transmit transaction, according to the present disclosure.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. The implementations set forth in the following description of embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

The present disclosure generally relates to data token transfers, and more particularly, to methods of and systems for transferring data tokens between autonomous agents.

The present disclosure also generally relates to methods of and systems for queuing data token exchanges for minimum time steps until an end timestamp is reached.

Moreover, the present disclosure also generally relates to methods of and systems for calculating an intersection price and a minimum time step.

Furthermore, the present disclosure also generally relates to methods of and systems for timing the execution of receive transaction(s), or transmit transaction(s), or both.

In one aspect, at a very high level, these methods and systems resolve problems in the art related to conventional matching engines. For example, in one aspect, for a conventional matching engine wherein matching is of finite value instantaneous, the conventional matching engine creates and enhances opportunities for latency arbitrage, front-running, toxic order-flow, etc., all of which increase the cost of trading. In the face of such issues, the methods and systems according to the present disclosure provide a solution to these deficiencies and more.

In one aspect, at a very high level, these methods and systems allow for a decentralized token exchange that can leverage an order book and that can match trades based on price and trading speed rather than quantity. In particular, in one aspect, demand and supply may be expressed as continuous functions mapping price to quantity per unit of time, i.e., trading speed (described in greater detail herein). In another aspect, single buy and sell orders may be aggregated across autonomous agents to produce demand and supply curves.

In one aspect, the methods and systems include two key components: an algorithm that constructs an aggregate demand or receive curve and an aggregate supply or transmit curve from single orders in an order book; and an algorithm that computes the market clearing price and trading speed from the aggregate demand/receive curve or from an aggregate supply/transmit curve.

In one aspect, autonomous agents for these methods and systems express demand and supply by associating price to trading speed, i.e., a quantity per a unit of time. In particular, in one aspect, a fundamental unit of an inventive concept according to the present disclosure is the advanced limit order. For example, in one specific aspect of one implementation, the advanced limit order may include a trade direction, a lower limit price, an upper limit price, a quantity, and a trading speed or a range of trading speeds and/or a trading speed maximum (also known as a trade speeding cap) (altogether making up, for example, an applicable data structure according to the present disclosure).

In one aspect, the systems and methods of the present disclosure may receive quantity data, and yet quantity data is not necessarily part of the advanced limit order. In another aspect of one implementation, quantity data is not necessary for the inventive features described in detail herein. In another aspect, quantity data is used and may, for example, be used to compute a minimum time based on a quantity and an intersection price or an intersection weight. In another aspect, quantity does not directly enter into an intersection price or intersection weight calculation; instead, the quantity impacts the duration over which an order or transfer or transaction executes, and it may result in a different average price or average weight.

In one aspect, these methods and systems allow for receive transaction(s) to execute at their maximum speed, below the lower limit price, and does not execute the receive transaction(s) at prices above the upper limit. In another aspect, in between these limits, the trading speed is linearly interpolated. In another aspect, these methods and systems allow for transmit transaction(s) to execute at their maximum speed for prices exceeding their upper limit and at zero speed for prices below the lower limit. In another aspect, these systems and methods take advantage of price fluctuations; automatically scaling trading speed without any intervention from the autonomous agents, for example. In this way, no autonomous agent or group of autonomous agents, no matter how well informed or technically sophisticated, is able to trade faster than at the maximum aggregate speed of the opposite side.

In one aspect, these systems and method can be practically implemented in a diverse array of market types or for a diverse array of data sources.

In one aspect, in stock markets, order matching systems and method according to the present disclosure may be tasked with the execution of trades for a wide range of equities and exchange-traded products. In another aspect, these systems and methods may process various order types and manage large volumes of transactions during market hours. In another aspect, these systems and methods may be configured to accommodate the intricacies of different trading strategies and participant preferences, ensuring that all market players have equitable access to trading opportunities.

In one aspect, in commodity markets, order matching systems and method according to the present disclosure may be tasked with delivery dates and storage considerations. In another aspect, these systems and methods may account for these factors and other similar factors, matching orders not only by price and time, for example, but also by delivery point and quality of the commodity.

In one aspect, in derivatives markets, order matching systems and method according to the present disclosure may be tasked with supporting the trading of contracts based on the future value of an underlying asset. In another aspect, these systems and methods may cater to a variety of expiration dates and strike prices, as well as complex trading strategies that are common in these markets.

In one aspect, in foreign exchange (Forex) markets, order matching systems and method according to the present disclosure may be tasked with operating around the clock, necessitating systems and methods that can function continuously across different time zones. In another aspect, given the high volume and rapid pace of Forex trading, these systems and methods may be robust and capable of processing a large number of transactions.

In one aspect, for cryptocurrency exchanges, order matching systems and method according to the present disclosure may be tasked with integrating into pre-existing distributed ledger infrastructure.

In one aspect, each of these autonomous agents may be associated with one or more requests to transfer data tokens. In addition to specifying a desired quantity of data tokens to be traded, these requests may also specify—either directly or indirectly—a rate at which the data tokens will be traded. This contrasts to traditional systems, which often involve only instantaneous transfers—which are essentially transfers with an infinitely high trading rate.

The functionality of order matching systems are subject to a range of technical and operational challenges that must be managed. One of the most significant challenges is the need to handle high volumes of orders, which can surge dramatically during periods of market volatility or economic announcements. The systems and methods according to the present disclosure are configured, in one aspect, with the capacity to process these peaks in activity.

High-frequency trading (HFT) presents another layer of complexity, as it involves the execution of orders at extremely high speeds, often by automated trading algorithms. Order matching systems must be equipped to interact with these algorithms effectively, managing the rapid submission, modification, and cancellation of orders that characterize HFT activity. The systems and methods according to the present disclosure are configured, in one aspect, to robustly withstand potential stresses and strains caused by such trading behavior.

In one aspect, to better address these issues, systems and method according to the present disclosure may be tasked with timing the transfer of data tokens between autonomous agents. At a high level, each of these autonomous agents may be associated with one or more requests to transfer data tokens. In addition to specifying a desired quantity of data tokens to be traded, these requests may also specify—either directly or indirectly—a rate at which the data tokens will be traded. This contrasts to traditional systems, which often involve only instantaneous transfers—which are essentially transfers with an infinitely high trading rate.

In one aspect, systems and method according to the present disclosure may be tasked with determining, for a list of transfer requests it has received, what transfers between what autonomous agents in what quantities should occur. Because this method is to determine these transfers rather than to execute them, these determinations may be queued by recording them in a ledger or other type of data structure that will later be used to effectuate the recorded data token transfers.

In one aspect, systems and method according to the present disclosure may be tasked with calculating transmit and receive curves based on the parameters of a plurality of queued transfer requests.

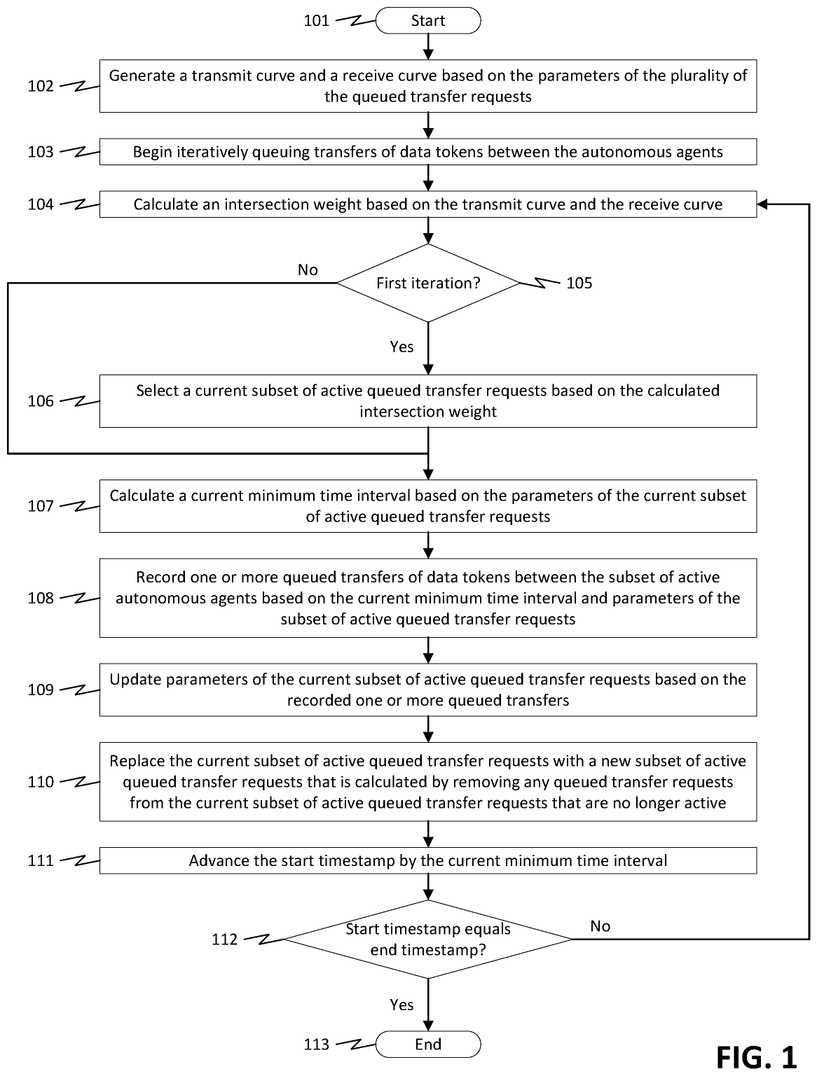

Turning now to the figures, FIG. 1 is a flowchart of a method of transferring data tokens between autonomous agents, according to an embodiment of the present disclosure. To start, as shown by block 102 of FIG. 1, the transmit curve and the receive curve may be generated.

In one aspect, the transmit curve is generated based on the parameters of the queued transfer requests. Similarly, in one aspect the receive curve is generated based on the parameters of the queued transfer requests.

In one aspect, the transmit and receive curves are piece-wise linear curves mapping resource weight to the overall transfer and receive flow rates. For example, in one aspect, for a transmit curve or a receive curve to be a piece-wise linear curve, they must be composed of only line segments that are together without gaps. Line segments are chained together without gaps when the ends of adjacent line segments touch without overlapping. The ends of the adjacent line segments form the points of the curve. The overall transfer and receive flow rates are calculated from the individual flow rate segments—which may be considered as individual “curves”—of the queued transfer requests.

Moreover, in another aspect, each start and end of the line segments composing the transmit curve or receive curve are a point along the transmit and receive curves. The leftmost and rightmost points of the transmit and receive curves are referred to as starting points and ending points of the transmit and receive curves (or vice-versa). As used herein, the points of the transmit and receive curves falling between the leftmost and rightmost points of the curves are referred to as intermediate points. Note that two points along a curve, e.g., along the transmit curve or receive curve, are “adjacent” (as used herein) if there are no other points along the curve that are positioned between those two points.

In one aspect, “flow rate” as used herein means the amount of data tokens being exchanged per unit time. For example, a specific value for a flow rate could be 100 data tokens per millisecond. Additionally, each queued transfer request may also be associated with a transfer sign. In general, the transfer sign may indicate a direction of the flow, i.e., may indicate whether the flow rate is for the number of data tokens being received or the number of data tokens being transmitted. A positive transfer sign may indicate that data tokens are being received while a negative transfer sign may indicate that data tokens are being transmitted.

In another aspect, these individual flow rate segments are implicit in each of the queued transfer requests. For example, a queued transfer request may comprise parameters indicating a maximum flow rate—such as number of data tokens per second—a transfer sign, an upper resource weight, and a lower resource weight. If the transfer sign of this queued transfer request is positive, then the flow rate segment for this queued transfer request may be the line segment starting with a flow rate of zero at the upper resource weight and ending with a flow rate of the given maximum flow rate at the lower resource weight. Alternatively, f the transfer sign of this queued transfer request is negative, then the flow rate segment for this queued transfer request may be the line segment starting with a flow rate of zero at the lower resource weight and ending with a flow rate of the given maximum flow rate at the upper resource weight.

In one aspect, the realized flow rates of each of the queued transfer requests—i.e., the rate at which data tokens are transferred to satisfy the order inherent in the recorded queued data token transfers for that order—are always less than the respective maximum flow rates of the queued transfer requests. In another aspect, the maximum flow rate of each of the queued transfer requests is always a finite (as opposed to infinite) value. In another aspect, the realized flow rates of each of the queued transfer requests are also always a finite (as opposed to infinite) value.

In one aspect, resource weights are determined for each of the plurality of queued transfer requests. In another aspect, the result of determining the resource weights are determined resource weights. In another aspect, the determined resource weights include a determined upper resource weight and a determined lower resource weight. In another aspect the resource weights for a queued transfer request are determined based on the control parameters associated with the queued transfer request.

In one aspect, each of the plurality of queued transfer requests are associated with a flow rate distribution function. In general, the flow rate distribution function distributes the flow rate between the line segment with one end starting at the lower resource weight of the queued transfer request and the other end starting at the upper resource weight of the queued transfer request. For example, in another aspect of a specific implementation, the flow rate distribution function is log-linear with respect to resource weight, meaning that the logarithm of the flow rate increases linearly with the logarithm of the resource weight.

Returning generally to FIG. 1, after generating the transmit and receive curves, as shown by block 103 of FIG. 1, an iterative process of queuing transfers of data tokens between the autonomous agents begins. In another aspect, the transmit curve and receive curves are evaluated to determine if they intersect. If so, the process may end with no data token transfers being queued if it is determined that the transmit and receive curves do not intersect.

In one aspect, these transfers may cover a period of time between a start timestamp and an end timestamp. In particular, in some aspects these transfers occur over multiple iterations, each of which may cover a certain period of time, i.e., a certain duration of time.

In another aspect, the end timestamp is based on a requested final timestamp and a plurality of initial operation timestamps associated with each one of the plurality of pending transfer requests. Generally speaking, the initial operation timestamp of a pending transfer request is the moment that the pending transfer request took effect. In another aspect, a pending transfer request may take effect from the time that they are first received. In another aspect, the requested final timestamp is for a timestamp occurring after the start timestamp.

In one aspect, the end timestamp may be determined by first iterating through the parameters of a plurality of pending transfer requests to determine if any of the plurality of pending transfer requests have an initial operation timestamp between the start timestamp and a requested final timestamp. In other words, to determine if any of the pending transfer requests became effective after the start timestamp but before the end timestamp. In another aspect, if more than one plurality of pending transfer requests has an initial operation timestamp falling between the start timestamp and the requested final timestamp, the earliest initial operation timestamps from these two or more initial operation timestamps is selected as the end timestamp. Otherwise, if there is only one pending transfer request that has an initial operation timestamp falling between the start timestamp and the requested final timestamp, that initial operation timestamp is selected as the end timestamp. Finally, if there are no pending transfer requests that have an initial operation timestamp falling between the start timestamp and the requested final timestamp, the requested final timestamp is selected as the end timestamp. As used here, “selecting” a timestamp as the end timestamp means setting the value of the end timestamp to the value of the selected timestamp.

Returning generally to FIG. 1, after the iterative process of queuing data token transfers is initiated, as shown by block 104 of FIG. 1, the intersection weight is calculated.

In one aspect, the intersection weight is calculated based on the transmit curve and the receive curve. In another aspect, the point at which the transmit curve and the receive curve intersect one another is referred to as the intersection point. In some aspects, the resource weight associated with the intersection point is referred to as the intersection weight.

For example, after calculating the intersection weight, as shown by block 105 of FIG. 1, it is determined if this is the first iteration of the iterative process of queuing transfers of data tokens. If this is not the first step of the iterative process, the method proceeds to block 107 of FIG. 1. Conversely, if this is the first step of the iterative process, the method proceeds to block 106 of FIG. 1.

If this is the first iteration of the iterative process, as shown by block 106 of FIG. 1, a current subset of active queued transfer requests is selected from the plurality of queued transfer requests. After block 106 of FIG. 1, the method proceeds to block 107 of FIG. 1.

In one aspect, the current subset of active queued transfer requests is selected from the plurality of queued transfer requests based on the calculated intersection weight.

In one aspect, the portion of the plurality of autonomous agents that are associated with at least one of the active queued transfer requests in the current subset of active queued transfer requests.

Returning generally to FIG. 1, and next, as shown by block 107 of FIG. 1, the current minimum time interval may be calculated.

In one aspect, each queued transfer request is associated with a resource quantity parameter. The resource quantity parameter indicates how many data tokens that queued transfer request is seeking to transfer. When the resource quantity parameter of a queued transfer request becomes zero, the queued transfer request is complete—there are no further data tokens transfers that remain to be queued for that transfer. Because the queued transfer request will not cause any further transfers, it will not have any further effect on what data token transfers will be queued on later iterations. A transfer request is said to be satisfied when its resource quantity parameter becomes zero.

In one aspect, the current minimum time interval is calculated based on the parameters of the current subset of active queued transfer requests. For instance, in another aspect, the current minimum time interval is calculated by first calculating, for each queued transfer request of the current active queued transfer requests, the amount of time that it would take at a current flow rate of that queued transfer request for that transfer request to be satisfied. In other words, the calculated amount of time is the length of time it would take for the resource quantity parameter of the queued resource request to be reduced to zero at the current flow rate of a queued transfer request.

In one aspect, the current flow rate of a queued transfer request is a value that is between zero percent and 100 percent of the maximum flow rate of the queued transfer request.

In another aspect, the current flow rate for a transfer request associated with a positive transfer sign is determined by multiplying the maximum flow rate of the queued transfer request with the quotient of the difference between the lower resource weight of the queued transfer request and the intersection weight divided by the difference between the upper resource weight of the queued transfer request with the lower resource weight of the queued transfer request.

In another aspect, the current flow rate for a transfer request associated with a negative transfer sign is determined by multiplying the maximum flow rate of the queued transfer request with the quotient of the difference between the intersection weight and the lower resource weight of the queued transfer request divided by the difference between the upper resource weight of the queued transfer request with the lower resource weight of the queued transfer request.

In one aspect, the current minimum time interval is represented as a fraction having a numerator and a denominator. In some of these aspects, a 2-tuple is used to store the numerator and denominator of the fraction representing the current minimum time interval. For the 2-tuple storing the current minimum time interval, the first element of the 2-tuple represents the numerator of the current minimum time interval and the second element represents the denominator of the current minimum time interval.

A tuple is a finite sequence or ordered list of numbers or, more generally, mathematical objects, which are called the elements of the tuple. An n-tuple is a tuple of n elements, where n is a non-negative integer. A 2-tuple—which is commonly called an ordered pair—is a tuple with 2 elements, e.g., (2, 1) or (“Blair”, “Alexander”). For a tuple, order matters. Take, for example, a tuple that represents a person's first name and last name. The first element is the person's first name and the second element is the person's last name. The tuple for “Blair Alexander” would be (“Blair”, “Alexander”). This tuple is not equivalent to the tuple (“Alexander”, “Blair”), which would instead indicate a person whose name was “Alexander Blair.”

Note that a fractional number means a number that is a fraction. Similarly, an integral number means a number that is an integer.

After calculating the current minimum time interval, as shown by block 108 of FIG. 1, one or more queued transfers of data tokens may be recorded.

In one aspect, the queued transfers of data tokens may be transfers between the autonomous agents. In another aspect, these transfers are queued between a subset of the autonomous agents that are active. The active autonomous agents are those autonomous agents that are associated with at least one of the active queued transfer requests.

In another aspect, these queued transfers may be based on the current minimum time interval and the parameters of the current subset of active queued transfer requests.

Returning generally to FIG. 1, after recording the one or more queued transfers of data tokens, as shown by block 109 of FIG. 1, the parameters of the queued transfer requests that are part of the current subset of active queued transfer requests may be updated.

In one aspect, these updates may be based on the one or more recorded queued transfers of data tokens. In another aspect, the one or more recorded queued transfers of data tokens are each data indicating a number of data tokens to be transferred, an autonomous agent that the data tokens are to be transferred to, and an autonomous agent that the data tokens are to be transferred from.

Returning generally to FIG. 1, after updating the parameters of the current subset of active queued transfer requests, as shown by block 110 of FIG. 1, the current subset of active queued transfer requests may be replaced with a new subset of active queued transfer requests.

In one aspect, replacing a current subset of active queued transfer requests means changing what group of queued transfer requests the identifier “the current subset of active queued transfer requests” points to. For instance, if the current subset of active queued transfer is implemented as a first list of queued transfer requests, then replacing the current subset of active queued transfer requests with a new subset of active queued transfer requests means to: (1) generate the new subset of active queued transfer requests by generating a second list of queued transfer requests, (2) discard the first list of queued transfer requests, and (3) use the just generated second list—which is representing the new subset of active queued transfer request—as the new current subset of active queued transfer requests.

Similarly, in another aspect, generating the initial current subset of active queued transfer requests by adding each selected queued transfer request to the current subset of active queued transfer requests means appending the queued transfer request—or a reference identifying the queued transfer request—to a list of queued transfer requests. Note that the very first queued transfer request that is appended may be appended to an empty list. Subsequent changes to the queued transfer requests, particularly removal of the queued transfer requests (e.g., when a queued transfer request is cancelled), may result in later queued transfer requests also being appended to an empty list.

In one aspect, the new subset of active queued transfer requests may be calculated by using the current subset of active queued transfer requests as a starting point. Then, from this starting point, any of the queued transfer requests—each of which was previously an active queued transfer request prior to this—may be analyzed to determine if they are still active.

For example, in one aspect, calculating the new subset of active queued transfer requests comprises first copying all the queued transfer requests in the current subset of active queued transfer requests. Then, this copy of the queued transfer request may be iterated through to find and remove any queued transfer requests that are no longer active.

In one aspect, a transfer request may no longer be active (i.e., may be inactive) when the value of its associated quantity parameter is zero. For example, in another aspect, each queued transfer request is associated with a resource quantity parameter. The resource quantity parameter indicates how many data tokens that queued transfer request is seeking to transfer. When the resource quantity parameter of a queued transfer request becomes zero, the queued transfer request is complete—there are no further data tokens transfers that remain to be queued for that transfer. Because the queued transfer request will not cause any further transfers, it will not have any further effect on what data token transfers will be queued on later iterations. A transfer request is said to be satisfied when its resource quantity parameter becomes zero.

After removing any inactive queued transfer requests, as shown by block 111 of FIG. 1, the start timestamp may be advanced by the current minimum time interval.

In one aspect, advancing a start timestamp may include adding the current value of the start timestamp with the current minimum time interval and setting the resulting sum as the new value for the start timestamp. For example, in one aspect the start timestamp may indicate a beginning of a specific time for which the transfer of data tokens will be calculated, such as 10:00:00 Coordinated Universal Time (UTC). In another aspect, advancing the start timestamp means incrementing this time by some number of seconds. For instance, if the minimum time interval was five seconds, then advancing the start time would mean to advance the start time from 10:00:00 UTC to 10:00:05 UTC.

In another aspect, if adding the current minimum time interval to the start timestamp would result in the updated start timestamp being greater than or equal to the end timestamp, the current minimum time interval may be clamped to be the difference between the end timestamp and the start timestamp.

Returning generally to FIG. 1, after advancing the start timestamp, as shown by block 112 of FIG. 1, it is determined if the first timestamp equals the end timestamp. If the first timestamp does not equal the end timestamp, the method returns to block 104 of FIG. 1. Conversely, if the first timestamp does equal the end timestamp, the method ends. In another aspect, prior to returning to block 104 FIG. 1, the transmit curve and the receive curve may be regenerated. The regenerated transmit curve and the regenerated receive curve may reflect the changes to the parameters of the active queued transfer requests that was done in block 109 of FIG. 1.

In one aspect, blocks 104, 105, and 107-112 are iteratively repeated multiple times before the start timestamp equals the end timestamp. In a different aspect, blocks 104, 105, and 107-112 may only occur once before the start timestamp matches the end timestamp. For instance, in another aspect the start timestamp matches the end timestamp with the start timestamp has the same numerical value as the end timestamp, i.e., when the start timestamp equals the end timestamp. If the end timestamp was 10:10:00 UTC, then the start timestamp would match the end timestamp if the start timestamp was also 10:10:00 UTC.

In one aspect, “if the start timestamp equals the end timestamp” may mean if the start timestamp is greater than or equal to the end timestamp. For instance, in another aspect the start timestamp matches the end timestamp with the start timestamp has a numerical value that matches or exceeds the end timestamp, i.e., when the start timestamp is greater than or equal the end timestamp. If the end timestamp was 10:42:21 UTC, then the start timestamp would match the end timestamp if the start timestamp was: (1) 10:42:21 UTC, (2) 10:42:22 UTC, or (3) 11:53:04 UTC.

As used here, iteratively repeating blocks 104, 105, and 107-112 means to perform the steps of those blocks an additional time—i.e., for an additional iteration—before then performing the steps of those blocks for yet another additional time—i.e., for yet another additional iteration—until the stopping condition is met. As described in block 112 of FIG. 1, the stopping condition for the iterative process of queuing transfers of data tokens is that the timestamp does not match the end timestamp. In other words, every block is gone through for an additional time before any block is gone through for a second additional time—the blocks are repeated together as a group.

Note that an initial iteration means the first iteration in a series of iterations. Using the iterative process of queuing transfers of data tokens just described as an example, the initial iteration would collectively refer to the first time—subsequent to the method being initiated in block 101 of FIG. 1—that the steps of blocks 104, 105, and 107-112 were performed.

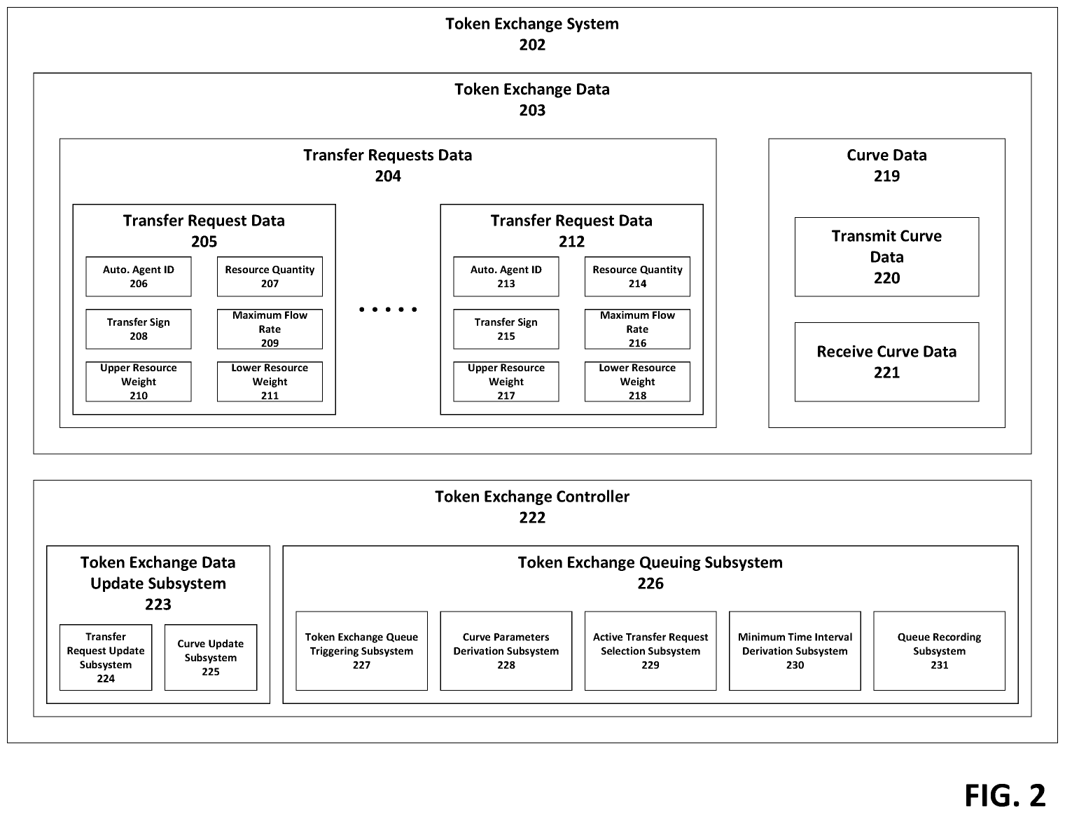

FIG. 2 shows a block diagram illustrating various structures of a token exchange system according to some embodiments of the present disclosure. As shown by the figure, a token exchange system 202 may comprise token exchange data 203 that is used and edited by a token exchange controller 222.

The token exchange controller 222 may comprise a token exchange data update subsystem 223 and a token exchange queuing subsystem 226. In turn, the token exchange data update subsystem 223 may comprise a transfer request update subsystem 224 and a curve update subsystem 225. The token exchange queuing subsystem 226 may comprise a token exchange queue triggering subsystem 227, a curve parameters derivation subsystem 228, an active queued transfer request selection subsystem 229, a minimum time interval derivation subsystem 230, and a queue recording subsystem 231.

The token exchange data 203 may comprise transfer requests data 204 and curve data 219. In general, the transfer requests data 204 may comprise one or more individual transfer request data, shown here as a transfer request data 205 and a transfer request data 212. The curve data 219 may comprise a transmit curve data 220 and a receive cure data 221. Each transfer request data may comprise a plurality of parameters, shown here as autonomous agent ID 206 and 213, resource quantity 207 and 214, transfer sign 208 and 215, maximum (max) flow rate 209 and 216, upper resource weight 210 and 217, and lower resource weight 211 and 218.

In one aspect, the curve parameters derivation subsystem 228 may calculate the intersection weight of the transmit and receive curves based on the curve data 219.

In one aspect, the resource quantity parameter indicates a number of data tokens that the transfer request is seeking to transfer. In another aspect, “data tokens” comprise digital data sufficient to effectuate the legal exchange of goods, services, currency, or other similar things of value. For example, a “data token” may comprise a quantity of United States dollars (USD) and a bank account number. As another example, a “data token” may comprise an amount of a coin of a cryptocurrency, such as a number of Bitcoins.

In one aspect, each of the queued transfer requests are associated with a flow rate slope. In some aspects, a flow rate slope is a numerical value indicating how much the current flow rate of the queued transfer request will increase per unit increase in the intersection weight.

In one aspect, the parameters of the queued transfer requests may be conceptually grouped into various categories. For example, in another aspect the parameters indicating the transfer sign, the maximum flow rate, the upper resource weight, and the lower resource weight are collectively referred to as control parameters. In another aspect, the control parameters comprise at least three separate parameters each indicating one of: (1) an upper resource weight, (2) a lower resource weight, (3) a maximum flow rate, and (4) a flow rate slope.

In one aspect, the resource quantity parameter and the transfer sign parameter are collectively referred to as resource parameters.

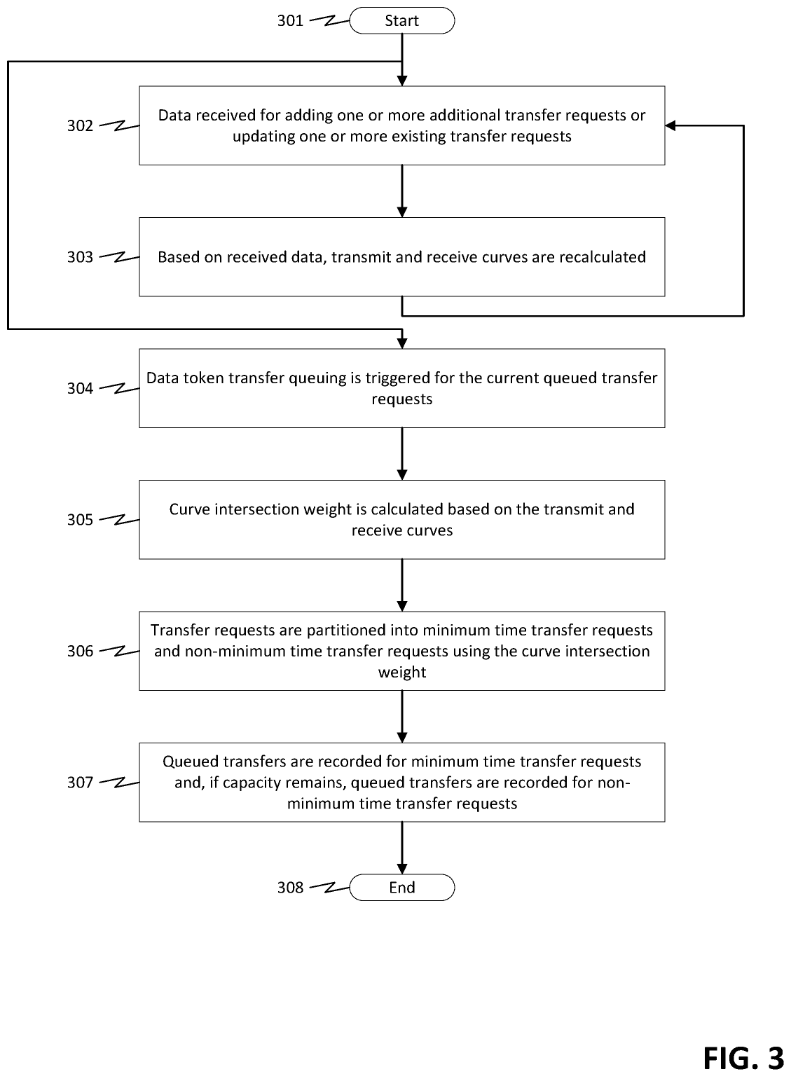

FIG. 3 is a flowchart illustrating a process of (1) updating transmit and receive curves as the plurality of queued transfer requests changes and (2) queuing transfer requests between the autonomous agents that generated the queued transfer requests for a designated interval of time.

To start, as shown by block 302 of FIG. 3, data is received for adding one or more additional transfer requests or updating one or more existing transfer requests.

After receiving the data, as shown by block 303 of FIG. 3, the transmit and receive curves may be recalculated based on the received data.

After updating the transmit receive curves, as shown by block 304 of FIG. 3, an iterative data token queuing procedure may be triggered.

In one aspect, the process of blocks 304-307 of FIG. 3 may be implemented as a function called execute_queued_transaction_requests_till_timestamp. In another aspect, the execute_queued_transaction_requests_till_timestamp function is designed to iterate over the queued transfer requests stored in the transfer requests data 204 and iteratively queue them for execution (i.e., queue them for transfer) up until the provided end timestamp.

In one aspect, the execute_queued_transaction_requests_till_timestamp function begins by ensuring that the specified start timestamp is greater than the end timestamp of the most recent time that execute_queued_transaction_requests_till_timestamp was called. In another aspect, this avoids duplicating already queued transfers of data tokens between the autonomous agents.

In one aspect, the execute_queued_transaction_requests_till_timestamp function enters a while loop that continues as long as the start timestamp is less than the end timestamp. Within this loop, several sub-functions are called to execute queued transfer requests and manage the token transfers between autonomous agents. In another aspect, the loop continues until all queued transfer requests that can be executed up to the end timestamp have been processed. After finishing the execution loop, the function ensures that any fully completed queued transfer requests are removed from the queued transfer request book.

After the data token queuing process is triggered, as shown by block 305 of FIG. 3, a curve intersection weight may be calculated based on the transmit and receive curves.

In one aspect, this is implemented as the first step in the loop of the execute_queued_transaction_requests_till_timestamp function. More precisely, in another aspect, the first step of the loop in the execute_queued_transaction_requests_till_timestamp function is to use the matching engine to find the intersection weight between the transmit and receive curves, which is the (market-)clearing weight at which transfers can occur.

In one aspect, the execute_queued_transaction_requests_till_timestamp uses the intersection weight to identify which queued transfer requests are active at this weight using the _queued_transaction_requests_executing_at_weight sub-function. The execute_queued_transaction_requests_till_timestamp function then determines the minimum time interval during which queued transfer requests will execute at the intersection weight with _minimum_time_within_executing_queued_transaction_requests.

In another aspect, the_queued_transaction_requests_executing_at_weight sub-function scans the list of queued transfer requests in the queued transfer request data 204 and determines which queued transfer requests are actively executing at a given weight, by comparing the intersection weight with the queued transfer request's weight range.

In another aspect, the_minimum_time_within_executing_queued_transaction_requests sub-function calculates the minimum time required for executing the queued transfer requests at the intersection weight. It compares the time to complete each queued transfer request against the remaining time in the update cycle and returns the sooner of the two.

Returning generally to FIG. 3, after the curve intersection weight is calculated, as shown by block 306 of FIG. 3, the current active queued transfer requests may be partitioned into minimum time active queued transfer requests and non-minimum time active queued transfer requests using the curve intersection weight.

After partitioning the current active queued transfer requests, as shown by block 307 of FIG. 3, queued exchanges may be recorded for the minimum time active queued transfer requests and, if capacity remains, queued exchanges may be recorded for non-minimum time active queued transfer requests.

In one aspect, once the minimum time step is determined, the function calls _execute_queued_transaction_requests_for_time_and_get_transferrable_tokens to queue transfers of data tokens based on the parameters of the queued transfer requests for this time step at the intersection weight. The resulting token transfer lists for autonomous agents are then processed in _execute_token_transfers_between_autonomous_agents to record the queued transactions to update their associated queued transfer requests to reflect that some or all of the queued transfer request has been (queued to later be) executed.

In another aspect, the function _compute_tokens_transferred_between_autonomous agents is used to determine how many tokens are transferred between the autonomous agents based on their queued transfer request parameters. For each transaction that occurs, the function updates the queued transfer requests involved to reflect the executed trade, modifying the quantity of tokens remaining or marking the queued transfer request as completed if it has been fully executed. The start timestamp is updated to reflect the progress made in executing the queued transfer requests.

In another aspect, the _execute_queued_transaction_requests_for_time_and_get_transferrable_tokens function is used to advance each eligible queued transfer request by the current minimum time interval and to calculate the number of data tokens that can be transferred between the autonomous agents.

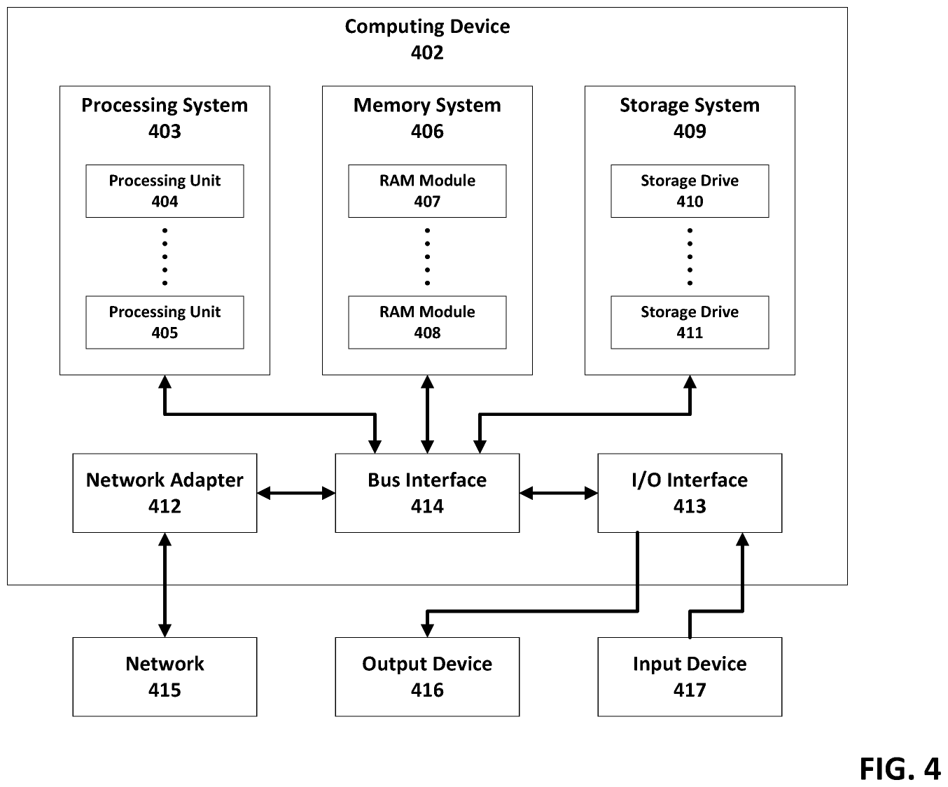

FIG. 4 shows a block diagram illustrating a computing device according to some embodiments of the present disclosure. As shown by the figure, a computing device 402 may comprise a processing system 403, a memory system 406, a storage system 409, a network adapter 412, an input/output (I/O) interface 413, a bus interface 414. The processing system 403 may comprise one or more processing units, shown here as processing units 404 and 405. Similarly, the memory system 406 may comprise one or more random access memory (RAM) modules, shown here as RAM modules 407 and 408. Likewise, the storage system 409 may comprise one or more storage drives, shown here as storage drives 410 and 411.

In general, the processing system 403, the memory system 406, the storage system 409, the network adapter 412, and the I/O interface 413 may be communicatively connected through the bus interface 414. Additionally, the network adapter 412 may be connected to one or more networks, shown here as network 415. The I/O interface 413 may likewise be connected to various external devices, shown here as output device 416 and input device 417. The bus interface 414 is the communication system that connects all the various components of the computing device 402. It facilitates data transfer between the processing system, memory system, storage system, network adapter, and I/O interface. The efficiency and bandwidth of the bus interface 414 may significantly affect the overall performance of the computing device, as it may sometimes determine how quickly data can be transferred between different components.

Processing system 403 may work to generally control and orchestrate the operation of the computing device 402. The processing units are 404 and 405 are generally responsible for executing instructions and processing data. They can be CPUs (Central Processing Units), GPUs (Graphics Processing Units), or specialized processors like DSPs (Digital Signal Processors). Each processing unit may have multiple cores, enabling parallel processing and enhancing the computational power of the device.

In general, the memory system 406 may provide a pool of volatile data storage that the processing system 403 may use to store in-use data and machine code. Volatile data storage, such as the RAM modules 407 and 408, fast read and write access. The more RAM available, the more information can be processed simultaneously, allowing for smoother multitasking and faster application performance.

The storage system 409 may provide a pool of non-volatile memory for long-term storage of data. The storage drives 410 and 411 may comprise a variety of storage technologies, including hard drive disks (HDDs), solid state disks (SSDs), magnetic-tape data storage, or hybrid configurations of these devices. These storage drives are non-volatile, meaning they retain data even when the device is powered off. They are used for long-term data storage, such as the operating system, applications, and user files.

The network adapter 412 is a component that may allow the computing device 402 to connect to external electronic networks, enabling communication with other devices and access to the internet. The network adapter 412 may utilize a wired connection, such as Ethernet or may utilize a wireless connection, such as Wi-Fi or Bluetooth. Similarly, the I/O interface 413 manages data connections with local device (e.g., peripherals). It may connect to various input devices, like keyboards or mice and various output devices, such as digital displays and printers.

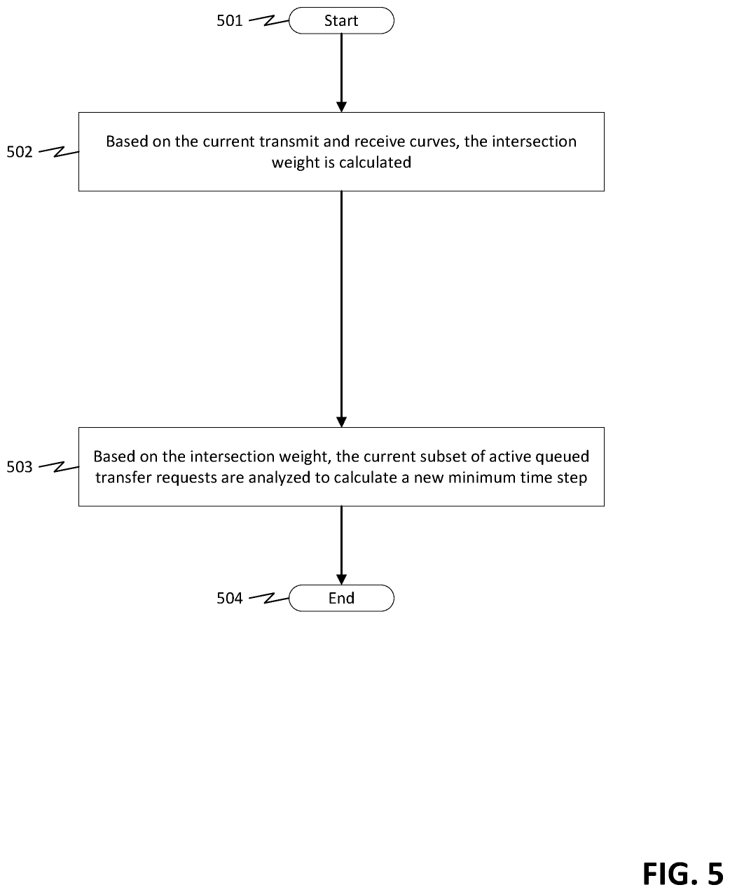

FIG. 5 is a flowchart of a method of calculating an intersection price and a minimum time step. To start, as shown by block 502 of FIG. 5, the intersection weight may be calculated based on the current transmit and receive curves.

After receiving the intersection weight, as shown by block 503 of FIG. 5, the current subset of active queued transfer requests is analyzed to calculate a new minimum time step.

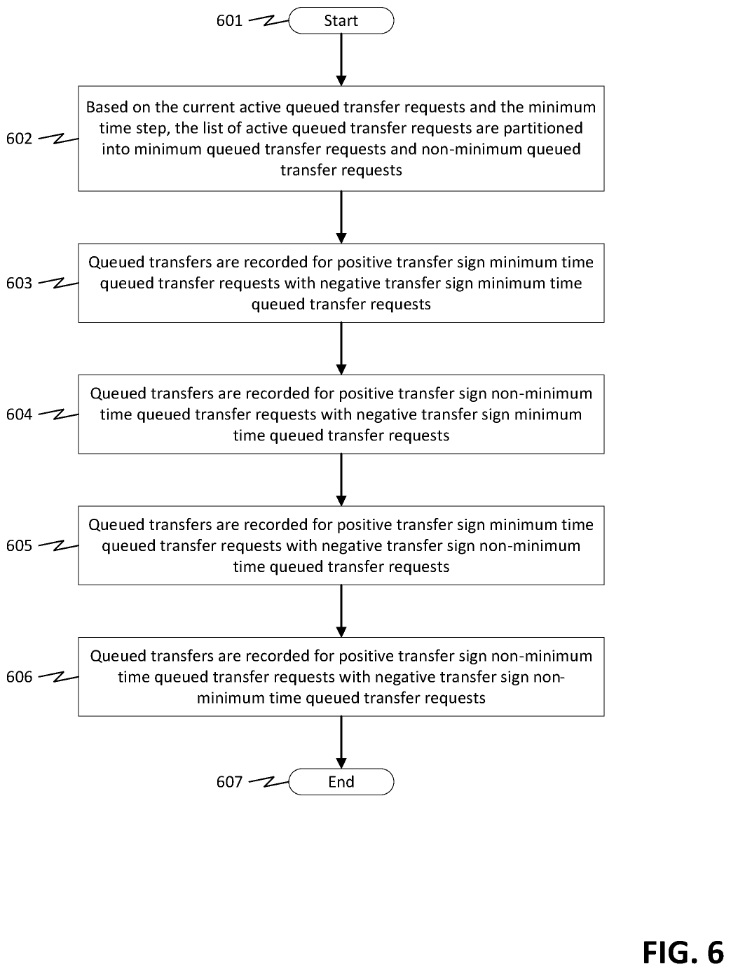

FIG. 6 is a flowchart of a method of queueing data token exchanges for a minimum time step. To start, as shown by block 602 of FIG. 6, the subset of active queued transfer requests may be partitioned into minimum queued transfer requests and non-minimum queued transfer requests based on the current minimum time step.

After partitioning the subset of active queued transfer requests, as shown by block 603 of FIG. 6, queued transfers may be recorded for positive transfer sign minimum time queued transfer requests with negative transfer sign minimum time queued transfer requests.

After recording these queued transfers of data tokens, as shown by block 604 of FIG. 6, Queued transfers may be recorded for positive transfer sign non-minimum time queued transfer requests with negative transfer sign minimum time queued transfer requests.

After recording these queued transfers of data tokens, as shown by block 605 of FIG. 6, Queued transfers may be recorded for positive transfer sign minimum time queued transfer requests with negative transfer sign non-minimum time queued transfer requests.

After recording these queued transfers of data tokens, as shown by block 606 of FIG. 6, queued transfers may be recorded for positive transfer sign non-minimum time queued transfer requests with negative transfer sign non-minimum time queued transfer requests.

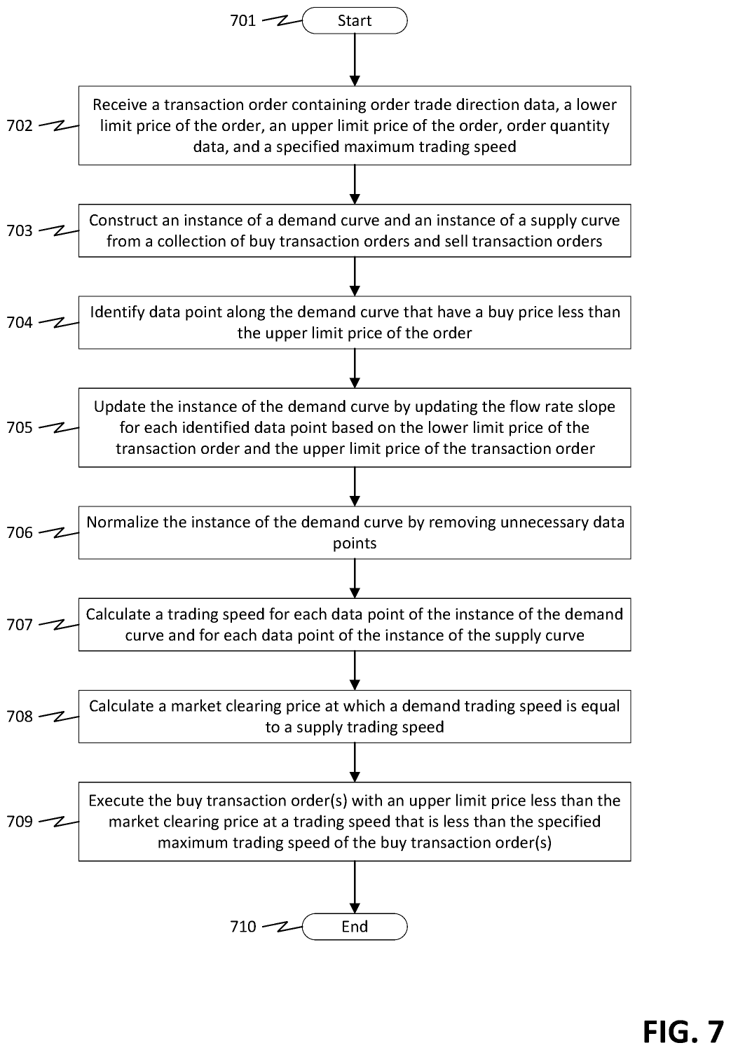

FIG. 7 is a flowchart of a method of timing the execution of a receive transaction. To start, as shown by block 702 of FIG. 7, a transaction order is received that contains order trade direction data, a lower limit price of the order, an upper limit price of the order, order quantity data, and a specified maximum trading speed.

Next, as shown by block 703 of FIG. 7, an instance of a demand curve and an instance of a supply curve are constructed from a collection of buy transaction orders and sell transaction orders.

Next, as shown by block 704 of FIG. 7, data point along the demand curve are identified that have a buy price less than the upper limit price of the order.

Next, as shown by block 705 of FIG. 7, the instance of the demand curve is updated by updating the flow rate slope for each identified data point based on the lower limit price of the transaction order and the upper limit price of the transaction order.

Next, as shown by block 706 of FIG. 7, the instance of the demand curve is normalized by removing unnecessary data points.

Next, as shown by block 707 of FIG. 7, a trading speed is calculated for each data point of the instance of the demand curve and for each data point of the instance of the supply curve.

Next, as shown by block 708 of FIG. 7, a market clearing price is calculated at which a demand trading speed is equal to a supply trading speed.

Next, as shown by block 709 of FIG. 7, the buy transaction order(s) with a lower limit price greater than the market clearing price are executed at a trading speed that is less than the specified maximum trading speed of the buy transaction order(s).

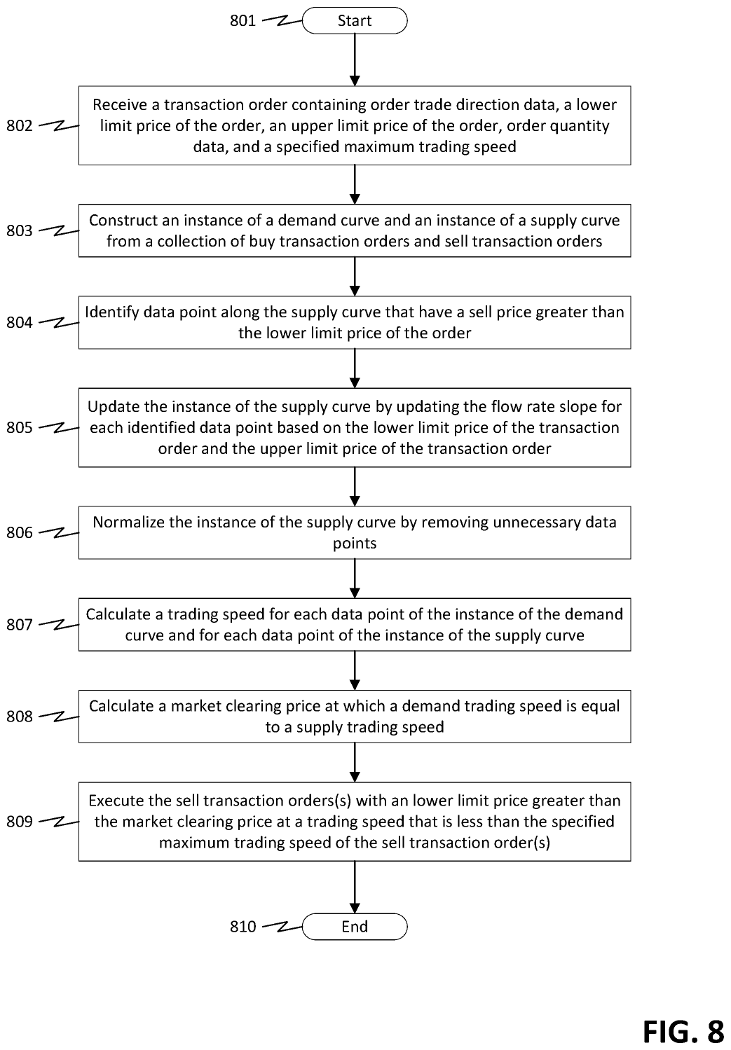

FIG. 8 is a flowchart of a method of timing the execution of a transmit transaction. To start, as shown by block 802 of FIG. 8, a transaction order is received that contains order trade direction data, a lower limit price of the order, an upper limit price of the order, order quantity data, and a specified maximum trading speed.

Next, as shown by block 803 of FIG. 8, an instance of a demand curve and an instance of a supply curve are constructed from a collection of buy transaction orders and sell transaction orders.

Next, as shown by block 804 of FIG. 8, data point along the supply curve are identified that have a sell price greater than the lower limit price of the order.

Next, as shown by block 805 of FIG. 8, the instance of the supply curve is updated by updating the flow rate slope for each identified data point based on the lower limit price of the transaction order and the upper limit price of the transaction order.

Next, as shown by block 806 of FIG. 8, the instance of the supply curve is normalized by removing unnecessary data points.

Next, as shown by block 807 of FIG. 8, a trading speed is calculated for each data point of the instance of the demand curve and for each data point of the instance of the supply curve.

Next, as shown by block 808 of FIG. 8, a market clearing price is calculated at which a demand trading speed is equal to a supply trading speed.

Next, as shown by block 809 of FIG. 8, the sell transaction order(s) with a lower limit price greater than the market clearing price are executed at a trading speed that is less than the specified maximum trading speed of the sell transaction order(s).

In some embodiments, a non-transitory computer-readable storage medium including instructions is also provided, and the instructions may be executed by a device, for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

The devices, modules, and other functional units described in this disclosure can be implemented by hardware, or software, or a combination of hardware and software. In some embodiments, functions described as being implemented in hardware may instead be implemented in software or a combination of hardware and software. Likewise, in some embodiments, functions described as being implemented in software may instead be implemented in hardware or a combination of hardware and software. If something is implemented by software, it may be stored in a non-transitory computer-readable media, like the computer-readable media described above. Such software, when executed by a processor, may perform the function of the device, module or other functional unit the software is implementing. The above-described devices, modules, and other functions units may also be combined or may be further divided into a plurality of sub-units.

In some places references are made to standards, including standard methods of performing particular tasks. These standards are revised from time to time, and, unless explicitly stated otherwise, reference to standards in this disclosure refer to the most recent published standard as of the time of filing.

Spatially relative terms, such as “under”, “below”, “lower”, “over”, “upper” and the like, may be used herein for ease of description to describe one element or feature's relationship to another when the apparatus is right side up.

When a feature is referred to as being “on” another feature, the feature may be directly on the other feature with no intervening features present or it may be indirectly on the other feature with intervening features being present. In contrast, when a feature is referred to as being “directly on” another feature, the feature is directly on the other feature with no intervening features present. It will also be understood that, when a feature is referred to as being “connected”, “attached” or “coupled” to another feature, the feature may be directly connected, attached or coupled to the other feature with no intervening features present or it may be indirectly connected, attached or coupled to the other feature with intervening features being present. In contrast, when a feature is referred to as being “directly connected”, “directly attached” or “directly coupled” to another feature, the feature is directly connected, directly attached, or directly coupled to the other feature with no intervening features present.

The terms “about” and “approximately” shall generally mean an acceptable degree of error or variation for the quantity measured given the nature or precision of the measurements. Typical, exemplary degrees of error or variation are within 20%, preferably within 10%, more preferably within 5%, and still more preferably within 1% of a given value or range of values. Numerical quantities given in this description are approximate unless stated otherwise, meaning that the term “about” or “approximately” can be inferred when not expressly stated.

Ordinal numbers or terms such as “first” and “second” are used only to differentiate an entity or operation from another entity or operation, and do not require or imply any actual relationship or sequence between these entities or operations. Thus, a first feature or element could be termed a second feature or element, and similarly, a second feature or element could be termed a first feature or element without departing from the teachings of the present disclosure. Moreover, the words “comprising,” “having,” “containing,” and “including,” and other similar forms are intended to be equivalent in meaning and be open ended in that any items following any one of these words is not meant to be an exhaustive listing of such items and is also not meant to be limited to only the listed items.

As used herein, unless specifically stated otherwise, the terms “or” and “at least one of” encompasses all possible combinations, except where infeasible. For example, if it is stated that a component may include “A or B,” then, unless specifically stated otherwise or infeasible, the component may include “A,” “B,” or “A and B.” As a second example, if it is stated that a component includes “at least one of A, B, or C,” then, unless specifically stated otherwise or infeasible, the component may include “A,” “B,” “C,” “A and B,” “A and C,” “B and C,” or “A, B, and C.” This same construction applies to longer lists (e.g., “may include A, B, C, or D”).

As used herein, the singular forms “a”, “an,” and “the” are intended to include the plural forms as well, unless the context clearly indicates otherwise.

Any statements in this disclosure criticizing or disparaging aspects of the prior art are not intended to indicate that what is claimed excludes any of those criticized or disparaged aspects of the prior art.

Any given element or step of the embodiments disclosed above may be embodied in a single element or step or may be embodied in multiple elements or steps. Moreover, any given element or step of the embodiments disclosed above may be combined and embodied in a single element or step or may be combined and embodied in multiple elements or steps.

The sequence of steps shown in the various figures are only for illustrative purposes and do not necessarily indicate that embodiments of the present disclosure are limited to any particular sequence of steps. As such, steps performed by various embodiments of the present disclosure can be performed in a different order while implementing the same method.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

### Claim Clauses:

Clause 1: A method for transferring data tokens between autonomous agents, comprising: generating a transmit curve based on parameters of a plurality of queued transfer requests, wherein each transfer request of the plurality of queued transfer requests is associated with one of a plurality of autonomous agents; generating a receive curve based on the parameters of the plurality of queued transfer requests; and queuing one or more transfers of data tokens between the autonomous agents for a period of time between a start timestamp until an end timestamp by: (1) calculating an intersection weight based on the transmit curve and the receive curve; (2) for an initial iteration, selecting a current subset of active queued transfer requests from the plurality of queued transfer requests based on the intersection weight and the parameters of the plurality of queued transfer requests; (3) calculating a current minimum time interval based on the parameters of the current subset of active queued transfer requests; (4) recording the one or more queued transfers of data tokens between a subset of active autonomous agents based on the current minimum time interval and the parameters of the current subset of active queued transfer requests, wherein the subset of active autonomous agents is a subset of the plurality of autonomous agents that are associated with at least one queued transfer request of the current subset of active queued transfer requests; (5) updating the parameters of the current subset of active queued transfer requests based on the one or more queued transfers; (6) replacing the current subset of active queued transfer requests with a new subset of active queued transfer requests calculated by removing any queued transfer requests from the current subset of active queued transfer requests that are no longer active; (7) advancing the start timestamp by the current minimum time interval; and (8) iteratively repeating steps (1) through (8) until the start timestamp matches the end timestamp.
Clause 2: The method of clause 1, further comprising transferring the data tokens between the plurality of autonomous agents based on the one or more recorded queued transfers.
Clause 3: The method of clause 1, wherein the start timestamp and the end timestamp are each a rational number stored as a fixed-point number having a fixed precision for a fractional part of the fixed-point number.
Clause 4: The method of clause 1, wherein the current minimum time interval is a fractional number stored as a 2-tuple of a first integral number and a second integral number, wherein: the first integral number represents a numerator of the fractional number; and the second integral number represents a denominator of the fractional number.
Clause 5: The method of clause 1, further comprising determining the end timestamp by: iterating through the parameters of a plurality of pending transfer requests to determine if any of the plurality of pending transfer requests have an initial operation timestamp between the start timestamp and a requested final timestamp, wherein each of the plurality of pending transfer requests is received from and is associated with one of the plurality of autonomous agents; and in response to determining there is at least one of the plurality of pending transfer requests that has the initial operation timestamp between the start timestamp and the requested final timestamp: determining an earliest initial operation timestamp of the plurality of pending transfer requests; comparing the earliest initial operation timestamp of the plurality of pending transfer requests with the requested final timestamp; and based on the comparison, selecting as the end timestamp the earlier of the earliest initial operation timestamp and the requested final timestamp.
Clause 6: The method of clause 1, wherein: each of the plurality of queued transfer requests is associated with resource parameters, wherein the resource parameters comprise a first resource parameter indicating quantity and a second resource parameter indicating a transfer sign; and each of the plurality of queued transfer requests is further associated with control parameters, wherein the control parameters comprise a first control parameter indicating an upper resource weight and a second control parameter indicating a lower resource weight.
Clause 7: The method of clause 6, wherein: the control parameters associated with each of the plurality of queued transfer requests further comprise a parameter indicating a maximum flow rate; and for each of the plurality of queued transfer requests, the maximum flow rate is linearly distributed between the lower resource weight indicated by the control parameters of a queued transfer request and the upper resource weight indicated by the control parameters of the queued transfer request.
Clause 8: The method of clause 6, wherein: the control parameters associated with each of the plurality of queued transfer requests further comprise a first parameter indicating a maximum flow rate and a second parameter indicating a flow rate distribution function; and for each of the plurality of queued transfer requests, the maximum flow rate is distributed between the lower resource weight indicated by the control parameters of a queued transfer request and the upper resource weight indicated by the control parameters of the queued transfer request based on the flow rate distribution function indicated by the control parameters of the queued transfer request.
Clause 9: The method of clause 8, wherein, for each of the plurality of queued transfer requests, the flow rate distribution function indicated by the control parameters of the queued transfer request is log-linear with respect to resource weight.
Clause 10: The method of clause 1, wherein: each of the plurality of queued transfer requests is associated with resource parameters, wherein the resource parameters comprise a first parameter indicating quantity and a second parameter indicating a transfer sign; each of the plurality of queued transfer requests is further associated with control parameters, wherein the control parameters comprise at least three parameters indicating: (1) an upper resource weight, (2) a lower resource weight, (3) a maximum flow rate, and (4) a flow rate slope; and the transmit curve and the receive curve are generated based on the control parameters associated with each of the plurality of queued transfer requests.
Clause 11: The method of clause 10, wherein selecting the current subset of active queued transfer requests for the initial iteration comprises: iterating through the plurality of queued transfer requests; selecting each queued transfer request associated with a parameter indicating an upper resource weight that is greater than the intersection weight and a parameter indicating lower resource weight that is less than the intersection weight; and; and adding each selected queued transfer request to the current subset of active queued transfer requests.
Clause 12: The method of clause 10, wherein calculating the current minimum time interval comprises: for each queued transfer request in the current subset of active queued transfer requests, calculating an amount of time that the first parameter indicating quantity of a queued transfer request will be satisfied, wherein the amount of time is calculated based on a current flow rate derived from the control parameters of the queued transfer request and the intersection weight; and selecting the least of the calculated amounts of time as the current minimum time interval.
Clause 13: The method of clause 10, wherein: the transmit curve is a first piecewise linear curve comprised of a transmit curve start point, a transmit curve end point, and a plurality of transmit curve intermediate points, and the receive curve is a second piecewise linear curve comprised of a receive curve start point, a receive curve end point, and a plurality of receive curve intermediate points, wherein: each transmit curve point and each receive curve point is associated with curve point parameters; and the curve point parameters comprise at least two parameters indicating: (1) a resource weight, (2) a flow rate, and (3) a flow rate slope.
Clause 14: The method of clause 13, wherein: the control parameters for each of the plurality of queued transfer requests are each a rational number stored as a fixed-point number having a fixed precision for a fractional part of the fixed-point number; and the curve point parameters for each transmit curve point, and for each receive curve point, are each a rational number stored as a fixed-point number having a fixed precision for a fractional part of the fixed-point number.
Clause 15: The method of clause 13, wherein calculating the intersection weight comprises: iterating through transmit curve points to determine a first transmit corner point and a second transmit corner point, wherein: the first transmit corner point and the second transmit corner point are adjacent; the first transmit corner point is associated with the curve point parameters indicating a first resource weight and a first flow rate such that: the first flow rate is less than a second flow rate of the receive curve at the first resource weight; and there is no other point of the transmit curve that is associated with the curve point parameters indicating a second resource weight and a third flow rate such that: (1) the third flow rate that is greater than the first flow rate; (2) the second resource weight is greater than the first resource weight; and (3) the third flow rate is less than a fourth flow rate of the receive curve at the second resource weight; and the second transmit corner point is associated with the curve point parameters indicating a third resource weight and a fifth flow rate such that: the fifth flow rate is greater than a sixth flow rate of the receive curve at the third resource weight; and there is no other point of the transmit curve that is associated with the curve point parameters indicating a fourth resource weight and a seventh flow rate such that: (1) the seventh flow rate that is less than the fifth flow rate; (2) the fourth resource weight is less than the third resource weight; and (3) the seventh flow rate is greater than an eighth flow rate of the receive curve at the fourth resource weight; iterating through receive curve points to determine a first receive corner point and a second receive corner point, wherein: the first receive corner point and the second receive corner point are adjacent; the first receive corner point is associated with the curve point parameters indicating a fifth resource weight and a ninth flow rate such that: the ninth flow rate is less than a tenth flow rate of the transmit curve at the fifth resource weight; and there is no other point of the receive curve that is associated with the curve point parameters indicating a sixth resource weight and an eleventh flow rate such that: (1) the eleventh flow rate that is greater than the ninth flow rate; (2) the sixth resource weight is less than the fourth resource weight; and (3) the eleventh flow rate is less than a twelfth flow rate of the transmit curve at the sixth resource weight; and the second receive corner point is associated with the curve point parameters indicating a seventh resource weight and a thirteenth flow rate such that: the thirteenth flow rate is greater than a fourteenth flow rate of the transmit curve at the seventh resource weight; and there is no other point of the receive curve that is associated with the curve point parameters indicating an eighth resource weight and a fifteenth flow rate such that: (1) the fifteenth flow rate that is less than the thirteenth flow rate; (2) the eighth resource weight is greater than the seventh resource weight; and (3) the fifteenth flow rate is greater than a sixteenth flow rate of the transmit curve at the eighth resource weight; calculating an intersection point between a first line between the first transmit corner point and second transmit corner point and a second line between the first receive corner point and second receive corner point, wherein the calculated intersection point is associated with a resource weight, a flow rate slope, and a flow rate; and using the resource weight of the calculated intersection point as the intersection weight.
Clause 16: The method of clause 13, further comprising: calculating the transmit curve by: determining, for each of the plurality of queued transfer requests associated with a negative transfer sign, an upper resource weight, and a lower resource rate, wherein the upper resource weight and the lower resource weight are determined based on the control parameters associated with each of the plurality of queued transfer requests; generating a point for each upper resource weights and lower resource weights associated with the plurality of queued transfer requests associated with a negative transfer sign, wherein each generated point is associated with a respective one of the determined upper resource weights and the determined lower resource weights; determining, for each generated point, the curve point parameters, wherein: determining, for a generated point, a parameter indicating resource weight comprises setting the parameter indicating resource weight to the determined resource weights associated with the generated point; determining, for a generated point, a parameter indicating a flow rate slope comprises: determining, for each of the plurality of queued transfer requests associated with a negative transfer sign, a flow rate slope, wherein the flow rate slope is determined based on the control parameters associated with each of the plurality of queued transfer requests; and composing respective flow rate slopes associated with the plurality of queued transfer requests associated with a negative transfer sign; and determining, for a generated point, a flow rate parameter comprises: determining, for each of the plurality of queued transfer requests associated with a negative transfer sign, a maximum flow rate, wherein the maximum flow rate is determined based on the control parameters associated with each of the plurality of queued transfer requests; and composing respective maximum flow rates associated with the plurality of queued transfer requests associated with a negative transfer sign; and calculating the receive curve by: determining, for each of the plurality of queued transfer requests associated with a positive transfer sign, an upper resource weight and a lower resource rate, wherein the upper resource weight and the lower resource weight are determined based on the control parameters associated with each of the plurality of queued transfer requests; generating a point for each of the determined resource weights associated with the plurality of queued transfer requests associated with a positive transfer sign, wherein each generated point is associated with a respective one of the determined upper resource weights and the determined lower resource weights; and determining, for each generated point, the curve point parameters, wherein: determining, for a generated point, a parameter indicating resource weight comprises setting the parameter indicating resource weight to the determined resource weight associated with the generated point; determining, for a generated point, a parameter indicating a flow rate slope comprises: determining, for each of the plurality of queued transfer requests associated with a positive transfer sign, a flow rate slope, wherein the flow rate slope is determined based on the control parameters associated with each of the plurality of queued transfer requests; and composing the respective flow rate slopes associated with the plurality of queued transfer requests associated with a positive transfer sign; and determining, for a generated point, a flow rate parameter comprises: determining, for each of the plurality of queued transfer requests associated with a positive transfer sign, a maximum flow rate, wherein the maximum flow rate is determined based on the control parameters associated with each of the plurality of queued transfer requests; and composing the respective maximum flow rates associated with the plurality of queued transfer requests associated with a positive transfer sign.
Clause 17: A system for transferring data tokens between autonomous agents, comprising: one or more memories storing a set of instructions; and one or more processors in communication with the one or more memories that are configured to execute the set of instructions stored in the one or more memories, wherein the one or more processors executing the set of instructions causes the system to: generate a transmit curve based on parameters of a plurality of queued transfer requests, wherein each transfer request of the plurality of queued transfer requests is associated with one of a plurality of autonomous agents; generate a receive curve based on the parameters of the plurality of queued transfer requests; and queue the one or more transfers of data tokens between the autonomous agents for a period of time between a start timestamp until an end timestamp by: (1) calculating an intersection weight based on the transmit curve and the receive curve; (2) for an initial iteration, selecting a current subset of active queued transfer requests from the plurality of queued transfer requests based on the intersection weight and the parameters of the plurality of queued transfer requests; (3) calculating a current minimum time interval based on the parameters of the current subset of active queued transfer requests; (4) recording one or more queued transfers of data tokens between a subset of active autonomous agents based on the current minimum time interval and the parameters of the current subset of active queued transfer requests, wherein the subset of active autonomous agents is a subset of the plurality of autonomous agents that are associated with at least one queued transfer request of the current subset of active queued transfer requests; (5) updating the parameters of the current subset of active queued transfer requests based on the one or more queued transfers; (6) replacing the current subset of active queued transfer requests with a new subset of active queued transfer requests calculated by removing any queued transfer requests from the current subset of active queued transfer requests that are no longer active; (7) advancing the start timestamp by the current minimum time interval; and (8) iteratively repeating steps (1) through (8) until the start timestamp matches the end timestamp.
Clause 18: The system of clause 17, wherein the one or more processors executing the set of instructions further cause the system to transfer the data tokens between the plurality of autonomous agents based on the one or more recorded queued transfers.
Clause 19: The system of clause 17, wherein the start timestamp and the end timestamp are each a rational value stored as a fixed-point number having a fixed precision for a fractional part of the fixed-point number.
Clause 20: The system of clause 17, wherein the current minimum time interval is a fractional number stored as a 2-tuple of a first integral number and a second integral number, wherein: the first integral number represents a numerator of the fractional number; and the second integral number represents a denominator of the fractional number.
Clause 21: The system of clause 17, wherein the one or more processors executing the set of instructions further cause the system to determine the end timestamp by: iterating through the parameters of a plurality of pending transfer requests to determine if any of the plurality of pending transfer requests have an initial operation timestamp between the start timestamp and a requested final timestamp, wherein each of the plurality of pending transfer requests is received from and is associated with one of the plurality of autonomous agents; and in response to determining there is at least one of the plurality of pending transfer requests that has the initial operation timestamp between the start timestamp and the requested final timestamp: determining an earliest initial operation timestamp of the plurality of pending transfer requests; comparing the earliest initial operation timestamp of the plurality of pending transfer requests with the requested final timestamp; and based on the comparison, selecting as the end timestamp the earlier of the earliest initial operation timestamp and the requested final timestamp.
Clause 22: The system of clause 17, wherein: each of the plurality of queued transfer requests is associated with resource parameters, wherein the resource parameters comprise a first resource parameter indicating quantity and a second resource parameter indicating a transfer sign; and each of the plurality of queued transfer requests is further associated with control parameters, wherein the control parameters comprise a first control parameter indicating an upper resource weight and a second control parameter indicating a lower resource weight.
Clause 23: The system of clause 22, wherein: the control parameters associated with each of the plurality of queued transfer requests further comprise a parameter indicating a maximum flow rate; and for each of the plurality of queued transfer requests, the maximum flow rate is linearly distributed between the lower resource weight indicated by the control parameters of a queued transfer request and the upper resource weight indicated by the control parameters of the queued transfer request.
Clause 24: The system of clause 22, wherein: the control parameters associated with each of the plurality of queued transfer requests further comprise a first parameter indicating a maximum flow rate and a second parameter indicating a flow rate distribution function; and for each of the plurality of queued transfer requests, the maximum flow rate is distributed between the lower resource weight indicated by the control parameters of a queued transfer request and the upper resource weight indicated by the control parameters of the queued transfer request based on the flow rate distribution function indicated by the control parameters of the queued transfer request.
Clause 25: The system of clause 24, wherein, for each of the plurality of queued transfer requests, the flow rate distribution function indicated by the control parameters of the queued transfer request is log-linear with respect to resource weight.
Clause 26: The system of clause 17, wherein: each of the plurality of queued transfer requests is associated with resource parameters, wherein the resource parameters comprise a first parameter indicating quantity and a second parameter indicating a transfer sign; each of the plurality of queued transfer requests is further associated with control parameters, wherein the control parameters comprise at least three parameters indicating: (1) an upper resource weight, (2) a lower resource weight, (3) a maximum flow rate, and (4) a flow rate slope; and the transmit curve and the receive curve are generated based on the control parameters associated with each of the plurality of queued transfer requests.
Clause 27: The system of clause 26, wherein the one or more processors executing the set of instructions cause the system to select the current subset of active queued transfer requests for the initial iteration by: iterating through the plurality of queued transfer requests; selecting each queued transfer request associated with a parameter indicating an upper resource weight that is greater than the intersection weight and a parameter indicating lower resource weight that is less than the intersection weight; and adding each selected queued transfer request to the current subset of active queued transfer requests.
Clause 28: The system of clause 26, wherein the one or more processors executing the set of instructions cause the system to calculate the current minimum time interval by: for each queued transfer request in the current subset of active queued transfer requests, calculating an amount of time that the first parameter indicating quantity of a queued transfer request will be satisfied, wherein the amount of time is calculated based on a current flow rate derived from the control parameters of the queued transfer request and the intersection weight; and selecting the least of the calculated amounts of time as the current minimum time interval.
Clause 29: The system of clause 26, wherein: the transmit curve is a first piecewise linear curve comprised of a transmit curve start point, a transmit curve end point, and a plurality of transmit curve intermediate points, and the receive curve is a second piecewise linear curve comprised of a receive curve start point, a receive curve end point, and a plurality of receive curve intermediate points, wherein: each transmit curve point and each receive curve point is associated with curve point parameters; and the curve point parameters comprise at least two parameters indicating: (1) a resource weight, (2) a flow rate, and (3) a flow rate slope.
Clause 30: The system of clause 29, wherein: the control parameters for each of the plurality of queued transfer requests are each a rational number stored as a fixed-point number having a fixed precision for a fractional part of the fixed-point number; and the curve point parameters for each the transmit curve point, and for each receive curve point, are each a rational value stored as a fixed-point number having a fixed precision for a fractional part of the fixed-point number.
Clause 31: The system of clause 29, wherein the one or more processors executing the set of instructions cause the system to calculate the intersection weight by: iterate through transmit curve points to determine a first transmit corner point and a second transmit corner point, wherein: the first transmit corner point and the second transmit corner point are adjacent; the first transmit corner point is associated with the curve point parameters indicating a first resource weight and a first flow rate such that: the first flow rate is less than a second flow rate of the receive curve at the first resource weight; and there is no other point of the transmit curve that is associated with the curve point parameters indicating a second resource weight and a third flow rate such that: (1) the third flow rate that is greater than the first flow rate; (2) the second resource weight is greater than the first resource weight; and (3) the third flow rate is less than a fourth flow rate of the receive curve at the second resource weight; and the second transmit corner point is associated with the curve point parameters indicating a third resource weight and a fifth flow rate such that: the fifth flow rate is greater than a sixth flow rate of the receive curve at the third resource weight; and there is no other point of the transmit curve that is associated with the curve point parameters indicating a fourth resource weight and a seventh flow rate such that: (1) the seventh flow rate that is less than the fifth flow rate; (2) the fourth resource weight is less than the third resource weight; and (3) the seventh flow rate is greater than an eighth flow rate of the receive curve at the fourth resource weight; iterate through the receive curve points to determine a first receive corner point and a second receive corner point, wherein: the first receive corner point and the second receive corner point are adjacent; the first receive corner point is associated with the curve point parameters indicating a fifth resource weight and a ninth flow rate such that: the ninth flow rate is less than a tenth flow rate of the transmit curve at the fifth resource weight; and there is no other point of the receive curve that is associated with the curve point parameters indicating a sixth resource weight and an eleventh flow rate such that: (1) the eleventh flow rate that is greater than the ninth flow rate; (2) the sixth resource weight is less than the fourth resource weight; and (3) the eleventh flow rate is less than a twelfth flow rate of the transmit curve at the sixth resource weight; and the second receive corner point is associated with the curve point parameters indicating a seventh resource weight and a thirteenth flow rate such that: the thirteenth flow rate is greater than a fourteenth flow rate of the transmit curve at the seventh resource weight; and there is no other point of the receive curve that is associated with the curve point parameters indicating an eighth resource weight and a fifteenth flow rate such that: (1) the fifteenth flow rate that is less than the thirteenth flow rate; (2) the eighth resource weight is greater than the seventh resource weight; and (3) the fifteenth flow rate is greater than a sixteenth flow rate of the transmit curve at the eighth resource weight; calculate an intersection point between a first line between the first transmit corner point and second transmit corner point and a second line between the first receive corner point and second receive corner point, wherein the calculated intersection point is associated with a resource weight, a flow rate slope, and a flow rate; and use the resource weight of the calculated intersection point as the intersection weight.
Clause 32: The system of clause 29, wherein the one or more processors executing the set of instructions further cause the system to: calculate the transmit curve by: determining, for each of the plurality of queued transfer requests associated with a negative transfer sign, an upper resource weight, and a lower resource rate, wherein the upper resource weight and the lower resource weight are determined based on the control parameters associated with each of the plurality of queued transfer requests; generating a point for each upper resource weights and lower resource weights associated with the plurality of queued transfer requests associated with a negative transfer sign, wherein each generated point is associated with a respective one of the determined upper resource weights and the determined lower resource weights; determining, for each generated point, curve point parameters, wherein: determining, for a generated point, a parameter indicating resource weight comprises setting the resource parameter indicating resource weight to the determined resource weights associated with the generated point; determining, for a generated point, a parameter indicating a flow rate slope comprises: determining, for each of the plurality of queued transfer requests associated with a negative transfer sign, a flow rate slope, wherein the flow rate slope is determined based on the control parameters associated with each of the plurality of queued transfer requests; and composing respective flow rate slopes associated with the plurality of queued transfer requests associated with a negative transfer sign; and determining, for a generated point, a flow rate parameter comprises: determining, for each of the plurality of queued transfer requests associated with a negative transfer sign, a maximum flow rate, wherein the maximum flow rate is determined based on the control parameters associated with each of the plurality of queued transfer requests; and composing respective maximum flow rates associated with the plurality of queued transfer requests associated with a negative transfer sign; and calculate the receive curve by: determining, for each of the plurality of queued transfer requests associated with a positive transfer sign, an upper resource weight and a lower resource rate, wherein the upper resource weight and the lower resource weight are determined based on the control parameters associated with each of the plurality of queued transfer requests; generating a point for each of the determined resource weights associated with the plurality of queued transfer requests associated with a positive transfer sign, wherein each generated point is associated with a respective one of the determined upper resource weights and the determined lower resource weights; and determining, for each generated point, the curve point parameters, wherein: determining, for a generated point, a parameter indicating resource weight comprises setting the parameter indicating resource weight to the determined resource weight associated with the generated point; determining, for a generated point, a parameter indicating a flow rate slope comprises: determining, for each of the plurality of queued transfer requests associated with a positive transfer sign, a flow rate slope, wherein the flow rate slope is determined based on the control parameters associated with each of the plurality of queued transfer requests; and composing the respective flow rate slopes associated with the plurality of queued transfer requests associated with a positive transfer sign; and determining, for a generated point, a flow rate parameter comprises: determining, for each of the plurality of queued transfer requests associated with a positive transfer sign, a maximum flow rate, wherein the maximum flow rate is determined based on the control parameters associated with each of the plurality of queued transfer requests; and composing the respective maximum flow rates associated with the plurality of queued transfer requests associated with a positive transfer sign.
Clause 33: The method of clause 6, wherein the parameters of the plurality of queued transfer requests comprise the resource parameters and the control parameters.
Clause 34: The system of clause 24, wherein the parameters of the plurality of queued transfer requests comprise the resource parameters and the control parameters.
Clause 35: A method of timing the execution of a receive transaction amongst a plurality of proposed transactions, comprising: (a) receiving a transaction order comprising: order direction data, a lower limit weight of the order, an upper limit weight of the order, order quantity data, and a specified maximum flow rate; (b) constructing an instance of a demand curve and an instance of a supply curve from a collection of receive transaction orders and transmit transaction orders; (c) updating the instance of the demand curve based at least on: the lower limit weight of the order, and the upper limit weight of the order, such that a flow rate slope for each data point along the demand curve, with a demand weight greater than the lower limit weight of the order, is updated; (d) normalizing the instance of the demand curve by removing unnecessary data points, and calculating a flow rate for each data point of the instance of the demand curve and for each data point of the instance of the supply curve; (e) calculating a market clearing weight at which a demand flow rate is equal to a supply flow rate; and (f) executing the receive transaction at the specified maximum flow rate of the order, below the lower limit weight of the order, and not executing the receive transaction(s) above the upper limit weight of the order.
Clause 36: The method of clause 35, wherein calculating the market clearing weight comprises using exact arithmetic using rational numbers.
Clause 37: The method of clause 35, wherein the instance of the demand curve is expressed as a continuous function mapping weight data to quantity data per unit of time from the collection of receive transaction orders, and wherein the instance of the supply curve is expressed as a continuous function mapping weight data to quantity data per unit of time from the collection of transmit transaction orders.
Clause 38: The method of clause 35, wherein constructing the instance of the demand curve and the instance of the supply curve comprises constructing an aggregate demand curve and an aggregate supply curve from the collection of receive transaction orders and transmit transaction orders.
Clause 39: The method of clause 35, wherein constructing the instance of the demand curve and the instance of the supply curve comprises constructing an aggregate demand curve and an aggregate supply curve from serialized data.
Clause 40: The method of clause 39, wherein the serialized data comprises quantity data, price data, and trade direction data.
Clause 41: The method of clause 35, wherein normalizing the instance of the demand curve by removing unnecessary data points, and calculating the flow rate for each data point of the instance of the demand curve and for each data point of the instance of the supply curve, comprises: (i) determining a leading data point of a segment of the demand curve with a non-zero flow rate slope; (ii) removing those data points having a zero flow rate slope and a zero trading speed, and preceding the leading data point, from the demand curve; (iii) if two successive data points of the segment of the demand curve have identical flow rate slopes, then removing the two successive data points; and (iv) calculating a demand flow rate for the instance of the demand curve and calculating a supply flow rate for the instance of the supply curve.
Clause 42: The method of clause 41, wherein calculating the demand flow rate for the instance of the demand curve and calculating the supply flow rate for the instance of the supply curve comprises calculating a demand flow rate at each data point in the instance of the demand curve and calculating a supply flow rate at each data point in the instance of the supply curve.
Clause 43: The method of clause 35, wherein calculating the market clearing weight at which the demand flow rate is equal to the supply flow rate, comprises: (i) determining an intersection data point or an intersection segment of the instance of the demand curve with the instance of the supply curve; and (ii) if the flow rate slope of the intersection data point, or if the flow rate slopes of the intersection segment, of the demand curve and the supply curve are non-zero, then calculating an intersection weight based on: (A) the intersection data point, or (B) data points bounding the intersection segment.
Clause 44: The method of clause 43, further comprising: if the intersection weight is less than or equal to a specified index weight in the instance of the demand curve, then calculating a flow rate at the intersection weight; using the instance of the supply curve, determining a maximum sell index of a group of indexes consisting of indexes having a specific index weight that is less than or equal to the intersection weight; and using the instance of the demand curve, determining a minimum buy index of a group of indexes consisting of indexes having a specific index weight that is greater than or equal to the intersection weight.
Clause 45: A method of timing the execution of a transmit transaction amongst a plurality of proposed transactions, comprising: (a) receiving a transaction order comprising: order direction data, a lower limit weight of the order, an upper limit weight of the order, order quantity data, and a specified maximum flow rate; (b) constructing an instance of a demand curve and an instance of a supply curve from a collection of receive transaction orders and transmit transaction orders; (c) updating the instance of the supply curve based at least on: the lower limit weight of the order, and the upper limit weight of the order, such that a flow rate slope for each data point along the supply curve, with a supply weight less than the upper limit weight of the order, is updated; (d) normalizing the instance of the supply curve by removing unnecessary data points, and calculating a flow rate for each data point of the instance of the demand curve and for each data point of the instance of the supply curve; (e) calculating a market clearing weight at which a demand flow rate is equal to a supply flow rate; and (f) executing the transmit transaction at the specified maximum flow rate of the order, above the upper limit weight of the order, and not executing the transmit transaction(s) below the upper limit weight of the order.
Clause 46: The method of clause 45, wherein calculating the market clearing weight comprises using exact arithmetic using rational numbers.
Clause 47: The method of clause 45, wherein the instance of the demand curve is expressed as a continuous function mapping weight data to quantity data per unit of time from the collection of receive transaction orders, and wherein the instance of the supply curve is expressed as a continuous function mapping weight data to quantity data per unit of time from the collection of transmit transaction orders.
Clause 48: The method of clause 45, wherein constructing the instance of the demand curve and the instance of the supply curve comprises constructing an aggregate demand curve and an aggregate supply curve from the collection of receive transaction orders and transmit transaction orders.
Clause 49: The method of clause 45, wherein constructing the instance of the demand curve and the instance of the supply curve comprises constructing an aggregate demand curve and an aggregate supply curve from serialized data.
Clause 50: The method of clause 49, wherein the serialized data comprising quantity data, weight data, and trade direction data.
Clause 51: The method of clause 45, wherein normalizing the instance of the supply curve by removing unnecessary data points, and calculating the flow rate for each data point of the instance of the demand curve and for each data point of the instance of the supply curve, comprises: (i) determining a leading data point of a segment of the supply curve with a non-zero flow rate slope; (ii) removing those data points having a zero flow rate slope and a zero trading speed, and preceding the leading data point, from the supply curve; (iii) if two successive data points of the segment of the supply curve have identical flow rate slopes, then removing the two successive data points; and (iv) calculating a demand flow rate for the instance of the demand curve and calculating a supply flow rate for the instance of the supply curve.
Clause 52: The method of clause 51, wherein calculating the demand flow rate for the instance of the demand curve and calculating the supply flow rate for the instance of the supply curve comprises calculating a demand flow rate at each data point in the instance of the demand curve and calculating a supply flow rate at each data point in the instance of the supply curve.
Clause 53: The method of clause 45, wherein calculating the market clearing weight at which the demand flow rate is equal to the supply flow rate, comprises: (i) determining an intersection data point or an intersection segment of the instance of the demand curve with the instance of the supply curve; and (ii) if the flow rate slope of the intersection data point, or if the flow rate slopes of the intersection segment, of the demand curve and the supply curve are non-zero, then calculating an intersection weight based on: (A) the intersection data point, or (B) data points bounding the intersection segment.
Clause 54: The method of clause 53, further comprising: if the intersection weight is greater than or equal to a specified index weight in the instance of the supply curve, then calculating a flow rate at the intersection weight; using the instance of the supply curve, determining a maximum sell index of a group of indexes consisting of indexes having a specific index weight that is less than or equal to the intersection weight; and using the instance of the demand curve, determining a minimum buy index of a group of indexes consisting of indexes having a specific index weight that is greater than or equal to the intersection weight.

Now, therefore, the following is claimed:

1. A method for transferring data tokens between autonomous agents, comprising:
generating a transmit curve based on parameters of a plurality of queued transfer requests, wherein each transfer request of the plurality of queued transfer requests is associated with one of a plurality of autonomous agents;
generating a receive curve based on the parameters of the plurality of queued transfer requests; and
queuing one or more transfers of data tokens between the autonomous agents for a period of time between a start timestamp until an end timestamp by:
(1) calculating an intersection weight based on the transmit curve and the receive curve;
(2) for an initial iteration, selecting a current subset of active queued transfer requests from the plurality of queued transfer requests based on the intersection weight and the parameters of the plurality of queued transfer requests;
(3) calculating a current minimum time interval based on the parameters of the current subset of active queued transfer requests;
(4) recording the one or more queued transfers of data tokens between a subset of active autonomous agents based on the current minimum time interval and the parameters of the current subset of active queued transfer requests, wherein the subset of active autonomous agents is a subset of the plurality of autonomous agents that are associated with at least one queued transfer request of the current subset of active queued transfer requests;
(5) updating the parameters of the current subset of active queued transfer requests based on the one or more queued transfers;
(6) replacing the current subset of active queued transfer requests with a new subset of active queued transfer requests calculated by removing any queued transfer requests from the current subset of active queued transfer requests that are no longer active;
(7) advancing the start timestamp by the current minimum time interval; and
(8) iteratively repeating steps (1) through (8) until the start timestamp matches the end timestamp.

2. The method of claim 1, further comprising transferring the data tokens between the plurality of autonomous agents based on the one or more recorded queued transfers.

3. The method of claim 1, wherein the start timestamp and the end timestamp are each a rational number stored as a fixed-point number having a fixed precision for a fractional part of the fixed-point number.

4. The method of claim 1, wherein the current minimum time interval is a fractional number stored as a 2-tuple of a first integral number and a second integral number, wherein:
the first integral number represents a numerator of the fractional number; and
the second integral number represents a denominator of the fractional number.

5. The method of claim 1, further comprising determining the end timestamp by:
iterating through the parameters of a plurality of pending transfer requests to determine if any of the plurality of pending transfer requests have an initial operation timestamp between the start timestamp and a requested final timestamp, wherein each of the plurality of pending transfer requests is received from and is associated with one of the plurality of autonomous agents; and
in response to determining there is at least one of the plurality of pending transfer requests that has the initial operation timestamp between the start timestamp and the requested final timestamp;
determining an earliest initial operation timestamp of the plurality of pending transfer requests;
comparing the earliest initial operation timestamp of the plurality of pending transfer requests with the requested final timestamp; and
based on the comparison, selecting as the end timestamp the earlier of the earliest initial operation timestamp and the requested final timestamp.

6. The method of claim 1, wherein:
each of the plurality of queued transfer requests is associated with resource parameters, wherein the resource parameters comprise a first resource parameter indicating quantity and a second resource parameter indicating a transfer sign; and
each of the plurality of queued transfer requests is further associated with control parameters, wherein the control parameters comprise a first control parameter indicating an upper resource weight and a second control parameter indicating a lower resource weight.

7. The method of claim 6, wherein:
the control parameters associated with each of the plurality of queued transfer requests further comprise a parameter indicating a maximum flow rate; and
for each of the plurality of queued transfer requests, the maximum flow rate is linearly distributed between the lower resource weight indicated by the control parameters of a queued transfer request and the upper resource weight indicated by the control parameters of the queued transfer request.

8. The method of claim 6, wherein:
the control parameters associated with each of the plurality of queued transfer requests further comprise a first parameter indicating a maximum flow rate and a second parameter indicating a flow rate distribution function; and
for each of the plurality of queued transfer requests, the maximum flow rate is distributed between the lower resource weight indicated by the control parameters of a queued transfer request and the upper resource weight indicated by the control parameters of the queued transfer request based on the flow rate distribution function indicated by the control parameters of the queued transfer request.

9. The method of claim 8, wherein, for each of the plurality of queued transfer requests, the flow rate distribution function indicated by the control parameters of the queued transfer request is log-linear with respect to resource weight.

10. The method of claim 1, wherein:
each of the plurality of queued transfer requests is associated with resource parameters, wherein the resource parameters comprise a first parameter indicating quantity and a second parameter indicating a transfer sign;
each of the plurality of queued transfer requests is further associated with control parameters, wherein the control parameters comprise at least three parameters indicating: (1) an upper resource weight, (2) a lower resource weight, (3) a maximum flow rate, and (4) a flow rate slope; and
the transmit curve and the receive curve are generated based on the control parameters associated with each of the plurality of queued transfer requests.

11. The method of claim 10, wherein selecting the current subset of active queued transfer requests for the initial iteration comprises:
iterating through the plurality of queued transfer requests;
selecting each queued transfer request associated with a parameter indicating an upper resource weight that is greater than the intersection weight and a parameter indicating lower resource weight that is less than the intersection weight; and
adding each selected queued transfer request to the current subset of active queued transfer requests.

12. The method of claim 10, wherein calculating the current minimum time interval comprises:
for each queued transfer request in the current subset of active queued transfer requests, calculating an amount of time that the first parameter indicating quantity of a queued transfer request will be satisfied, wherein the amount of time is calculated based on a current flow rate derived from the control parameters of the queued transfer request and the intersection weight; and
selecting the least of the calculated amounts of time as the current minimum time interval.

13. The method of claim 10, wherein:
the transmit curve is a first piecewise linear curve comprised of a transmit curve start point, a transmit curve end point, and a plurality of transmit curve intermediate points, and the receive curve is a second piecewise linear curve comprised of a receive curve start point, a receive curve end point, and a plurality of receive curve intermediate points, wherein:
each transmit curve point and each receive curve point is associated with curve point parameters; and
the curve point parameters comprise at least two parameters indicating: (1) a resource weight, (2) a flow rate, and (3) a flow rate slope.

14. The method of claim 13, wherein:
the control parameters for each of the plurality of queued transfer requests are each a rational number stored as a fixed-point number having a fixed precision for a fractional part of the fixed-point number; and
the curve point parameters for each transmit curve point, and for each receive curve point, are each a rational number stored as a fixed-point number having a fixed precision for a fractional part of the fixed-point number.

15. The method of claim 13, wherein calculating the intersection weight comprises:
iterating through transmit curve points to determine a first transmit corner point and a second transmit corner point, wherein:
the first transmit corner point and the second transmit corner point are adjacent;
the first transmit corner point is associated with the curve point parameters indicating a first resource weight and a first flow rate such that:
the first flow rate is less than a second flow rate of the receive curve at the first resource weight; and
there is no other point of the transmit curve that is associated with the curve point parameters indicating a second resource weight and a third flow rate such that: (1) the third flow rate that is greater than the first flow rate; (2) the second resource weight is greater than the first resource weight; and (3) the third flow rate is less than a fourth flow rate of the receive curve at the second resource weight; and
the second transmit corner point is associated with the curve point parameters indicating a third resource weight and a fifth flow rate such that:
the fifth flow rate is greater than a sixth flow rate of the receive curve at the third resource weight; and
there is no other point of the transmit curve that is associated with the curve point parameters indicating a fourth resource weight and a seventh flow rate such that: (1) the seventh flow rate that is less than the fifth flow rate; (2) the fourth resource weight is less than the third resource weight; and (3) the seventh flow rate is greater than an eighth flow rate of the receive curve at the fourth resource weight;
iterating through receive curve points to determine a first receive corner point and a second receive corner point, wherein:
the first receive corner point and the second receive corner point are adjacent;
the first receive corner point is associated with the curve point parameters indicating a fifth resource weight and a ninth flow rate such that:
the ninth flow rate is less than a tenth flow rate of the transmit curve at the fifth resource weight; and
there is no other point of the receive curve that is associated with the curve point parameters indicating a sixth resource weight and an eleventh flow rate such that: (1) the eleventh flow rate that is greater than the ninth flow rate; (2) the sixth resource weight is less than the fourth resource weight; and (3) the eleventh flow rate is less than a twelfth flow rate of the transmit curve at the sixth resource weight; and
the second receive corner point is associated with the curve point parameters indicating a seventh resource weight and a thirteenth flow rate such that:
the thirteenth flow rate is greater than a fourteenth flow rate of the transmit curve at the seventh resource weight; and
there is no other point of the receive curve that is associated with the curve point parameters indicating an eighth resource weight and a fifteenth flow rate such that: (1) the fifteenth flow rate that is less than the thirteenth flow rate; (2) the eighth resource weight is greater than the seventh resource weight; and (3) the fifteenth flow rate is greater than a sixteenth flow rate of the transmit curve at the eighth resource weight;
calculating an intersection point between a first line between the first transmit corner point and second transmit corner point and a second line between the first receive corner point and second receive corner point, wherein the calculated intersection point is associated with a resource weight, a flow rate slope, and a flow rate; and
using the resource weight of the calculated intersection point as the intersection weight.

16. The method of claim 13, further comprising:
calculating the transmit curve by:
determining, for each of the plurality of queued transfer requests associated with a negative transfer sign, an upper resource weight, and a lower resource rate, wherein the upper resource weight and the lower resource weight are determined based on the control parameters associated with each of the plurality of queued transfer requests;
generating a point for each upper resource weights and lower resource weights associated with the plurality of queued transfer requests associated with a negative transfer sign, wherein each generated point is associated with a respective one of the determined upper resource weights and the determined lower resource weights;
determining, for each generated point, the curve point parameters, wherein:
determining, for a generated point, a parameter indicating resource weight comprises setting the parameter indicating resource weight to the determined resource weights associated with the generated point;
determining, for a generated point, a parameter indicating a flow rate slope comprises:
determining, for each of the plurality of queued transfer requests associated with a negative transfer sign, a flow rate slope, wherein the flow rate slope is determined based on the control parameters associated with each of the plurality of queued transfer requests; and
composing respective flow rate slopes associated with the plurality of queued transfer requests associated with a negative transfer sign; and
determining, for a generated point, a flow rate parameter comprises:
determining, for each of the plurality of queued transfer requests associated with a negative transfer sign, a maximum flow rate, wherein the maximum flow rate is determined based on the control parameters associated with each of the plurality of queued transfer requests; and
composing respective maximum flow rates associated with the plurality of queued transfer requests associated with a negative transfer sign; and
calculating the receive curve by:
determining, for each of the plurality of queued transfer requests associated with a positive transfer sign, an upper resource weight and a lower resource rate, wherein the upper resource weight and the lower resource weight are determined based on the control parameters associated with each of the plurality of queued transfer requests;
generating a point for each of the determined resource weights associated with the plurality of queued transfer requests associated with a positive transfer sign, wherein each generated point is associated with a respective one of the determined upper resource weights and the determined lower resource weights; and
determining, for each generated point, the curve point parameters, wherein:
determining, for a generated point, a parameter indicating resource weight comprises setting the parameter indicating resource weight to the determined resource weight associated with the generated point;
determining, for a generated point, a parameter indicating a flow rate slope comprises:
determining, for each of the plurality of queued transfer requests associated with a positive transfer sign, a flow rate slope, wherein the flow rate slope is determined based on the control parameters associated with each of the plurality of queued transfer requests; and
composing the respective flow rate slopes associated with the plurality of queued transfer requests associated with a positive transfer sign; and
determining, for a generated point, a flow rate parameter comprises:
determining, for each of the plurality of queued transfer requests associated with a positive transfer sign, a maximum flow rate, wherein the maximum flow rate is determined based on the control parameters associated with each of the plurality of queued transfer requests; and
composing the respective maximum flow rates associated with the plurality of queued transfer requests associated with a positive transfer sign.

17. A system for transferring data tokens between autonomous agents, comprising:
one or more memories storing a set of instructions; and
one or more processors in communication with the one or more memories that are configured to execute the set of instructions stored in the one or more memories, wherein the one or more processors executing the set of instructions causes the system to:
generate a transmit curve based on parameters of a plurality of queued transfer requests, wherein each transfer request of the plurality of queued transfer requests is associated with one of a plurality of autonomous agents;
generate a receive curve based on the parameters of the plurality of queued transfer requests; and
queue the one or more transfers of data tokens between the autonomous agents for a period of time between a start timestamp until an end timestamp by:
(1) calculating an intersection weight based on the transmit curve and the receive curve;
(2) for an initial iteration, selecting a current subset of active queued transfer requests from the plurality of queued transfer requests based on the intersection weight and the parameters of the plurality of queued transfer requests;
(3) calculating a current minimum time interval based on the parameters of the current subset of active queued transfer requests;
(4) recording one or more queued transfers of data tokens between a subset of active autonomous agents based on the current minimum time interval and the parameters of the current subset of active queued transfer requests, wherein the subset of active autonomous agents is a subset of the plurality of autonomous agents that are associated with at least one queued transfer request of the current subset of active queued transfer requests;
(5) updating the parameters of the current subset of active queued transfer requests based on the one or more queued transfers;
(6) replacing the current subset of active queued transfer requests with a new subset of active queued transfer requests calculated by removing any queued transfer requests from the current subset of active queued transfer requests that are no longer active;
(7) advancing the start timestamp by the current minimum time interval; and
(8) iteratively repeating steps (1) through (8) until the start timestamp matches the end timestamp.

18. The system of claim 17, wherein the one or more processors executing the set of instructions further cause the system to transfer the data tokens between the plurality of autonomous agents based on the one or more recorded queued transfers.

19. The system of claim 17, wherein the start timestamp and the end timestamp are each a rational value stored as a fixed-point number having a fixed precision for a fractional part of the fixed-point number.

20. The system of claim 17, wherein the current minimum time interval is a fractional number stored as a 2-tuple of a first integral number and a second integral number, wherein:
the first integral number represents a numerator of the fractional number; and
the second integral number represents a denominator of the fractional number.
